(19) United States
(12) Patent Application Publication
(10) Pub. No.: US 2009/0001870 A1
(43) Pub. Date: Jan. 1, 2009

(54) Image Display Apparatus

(75) Inventors: Mutsumi Suzuki, Kodaira (JP); Masakazu Sagawa, Inagi (JP); Yoshiro Mikami, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/127,869

(22) Filed: May 28, 2008

(30) Foreign Application Priority Data
Jun. 28, 2007 (JP) 2007-170012

(51) Int. Cl. H01J 1/62

(52) U.S. Cl. 313/502

(57) ABSTRACT

A protruded portion of an adjacent scan line is provided along one of longer sides of an electron emission area, for functioning as a focusing electrode. A feeding electrode is provided along the other longer side of the electron emission part. Use of this arrangement improves the ability to feed current from a scan line(s). Thus, a distribution of drive current within an element electrode is dispersed, thereby to improve the reliability of an electron emission element. Additionally, in the case of a thin-film electron source being used as this element, the improvement in current feeding ability enables a top electrode to decrease in thickness, thus increasing the electron emission efficiency.

### INCORPORATION BY REFERENCE

The present application claims priority from Japanese application JP 2007-170012 filed on Jun. 28, 2007, the content of which is hereby incorporated by reference into this application.

### BACKGROUND OF THE INVENTION

### Field of the Invention

The present invention relates to image display apparatuses of the type displaying images by using a matrix array of electron emission elements and phosphors.

A matrix electron emitter display apparatus has a matrix of rows and columns of pixels at intersections of orthogonally crossing electrodes, and electron emission elements which are provided in respective pixels. An electron emitted from each electron emission element is accelerated in a vacuum while adjusting an amount of electron emission by control of either the amplitude or pulse width of a voltage being applied to each electron emission element. The accelerated electron then reaches and hits a phosphor, which thus yields light at its irradiated portion. Examples of the electron emission element include an electron emitter using a field-emission cathode, an electron emitter using a metal-insulator-metal (MIM) electron source, one using a carbon nanotube cathode, one using a diamond cathode, one using a surface-conduction electron emitter (SCE), and one using a ballistic surface electron emitter. In short, the matrix electron emitter display refers to an electron beam-excited flat panel display (FPD) using electron emission elements and phosphors in combination, also known as cathode-luminescent FPD.

As shown in FIG. 2, the matrix electron emitter display is typically arranged to have a cathode plate 601 with electron emission elements being disposed thereon and a phosphor plate 602 with a phosphor film formed thereon, wherein these plates 601 and 602 are disposed to spatially oppose each other. For enabling excitation and light emission of a phosphor on the phosphor plate due to the arrival of electrons emitted from an electron emission element 301, the inner space defined by the cathode and phosphor plates plus a frame component 603 is held in a vacuum. Spacers (supporting posts) 60 are inserted into the space between the cathode and phosphor plates to thereby provide the required withstandability against external application of atmospheric pressures.

The phosphor plate 602 has an acceleration electrode 122, to which a high voltage of about 3 to 10 kilovolts (kV) is applied. An electron emitted from electron emission element 301 is accelerated by this high voltage and then hits or “bombards” a phosphor, resulting in this phosphor being excited to emit light.

A thin-film electron emitter is employable as the electron emission element for use in matrix electron emitter display. This thin-film electron emitter is an electron emitter of the type having a multilayer structure of a top electrode, an electron acceleration layer and a base electrode. Examples of it are a metal-insulator-metal (MIM) electron emitter, metal-oxide-semiconductor (MOS) electron emitter, and ballistic surface electron emitter. A structure of MIM electron emitter is disclosed, for example, in JP-A-2004-363075. The MOS electron emitter is the one that employs a semiconductor/insulator multilayer film as the electron accelerator layer, an example of which is found in Japanese Journal of Applied Physics, Vol. 36, Part 2, No. 7B, pp. L939-L941 (1997). The ballistic surface electron emitter is the one that uses porous silicon or the like, as taught from Japanese Journal of Applied Physics, Vol. 34, Part 2, No. 6A, pp. L705-L707 (1995). The thin-film electron emitter produces electrons, which are accelerated within an electron accelerator layer and then emitted into a vacuum. The MIM electron emitter is the one that has top and base electrodes, each of which is made of a metal, and an electron accelerator layer made of an insulator. An example of the MIM electron source is recited in IEEE Transactions on Electron Devices, Vol. 49, No. 6, pp. 1059-1065 (2002).

FIGS. 3 is an energy band diagram for explaining the operation principle of a thin-film electron emitter having a multilayer structure of a top electrode 11, electron acceleration layer 12, and base electrode 13. In the state shown herein, a positive voltage is applied to top electrode 11. In the case of the MIM electron emitter, electron accelerator layer 12 is made of an insulator. Upon application of the voltage between the top and base electrodes, an electric field is created within electron accelerator layer 12. By this electric field, electrons are forced to flow by tunneling phenomenon from base electrode 13 into electron accelerator layer 12. These electrons are then accelerated by the electric field in electron accelerator layer 12 and thus become “hot” electrons. When the hot electrons pass through inside of top electrode 11, some of them lose energy due to inelastic scattering or else. When the remaining electrons reach an interface between top electrode 11 and vacuum 10 (i.e., the surface of top electrode), an electron which has its kinetic energy that is greater than the workfunction Φ of the surface is released into vacuum 10. In this specification, an electrical current flowing between base electrode 13 and top electrode 11 due to such hot electrons is called the diode current Jd, and a current being emitted to the vacuum is called the emission current Je.

The thin-film electron emitter is superior to field-emission type cathodes in durability against surface contamination. In addition, the former is less than the latter in spreading or divergence of a beam of electrons emitted. Thus, the thin-film electron emitter offers features suitable for application to image display apparatuses: its operation voltage is relatively low; and, drivers in drive circuitry are properly operable at low voltages. Having these features makes it possible to achieve high-definition display apparatuses with increased image resolutions.

In the thin-film electron emitter, only part of a drive current is emitted into the vacuum (emission current Je). Note here that the drive current is a current flowing between the top and base electrodes, and is also called as diode current Jd. A ratio α of the emission current Je to diode current Jd (i.e., electron emission ratio α=Je/Jd) is about 0.1 to several tens of percent (%). Consequently, in order to obtain the emission current Je, a drive current (diode current) of Jd=Je/α should be supplied from the drive circuit to thin-film electron emitter. This emission ratio α is also called the electron emission efficiency.

In this way, in the matrix electron emitter display using thin-film electron emitters as its electron emission elements, drive current tends to be large. This makes it necessary to sufficiently increase the ability to feed electrical current from an electrode wiring to electron emission-element's electrode (between the top and base electrodes, in this case).

In the matrix electron emitter display using thin-film electron emitters as its electron emission elements, it is required to increase the electron emission ratio α=Je/Jd in order to reduce the drive current. One available approach to increasing the electron emission ratio α is to reduce the film thickness of the top electrode. This thickness reduction leads to a decrease in scattering probability of hot electrons within the top electrode, resulting in a likewise increase in electron emission ratio α. Note however that it is required to employ a specifically designed electron emission element's structure in order to make the top electrode thinner, which structure is capable of sufficiently retaining the ability to feed current to electron emission elements even when the top electrode is made thinner.

Another example of the electron emission element usable for the matrix electron emitter display is a surface-conduction electron emitter (SCE) element. This SCE element is disclosed, for example, in Journal of the Society for Information Display (SID), Vol. 5, pp. 345-348 (1997). As shown in FIG. 4, the SCE element has an anode electrode film 811 and a cathode electrode film 813, with a gap of a few to several tens of nm being defined therebetween. Upon application of a voltage of 10V to 20V between the anode and cathode electrodes 811 and 813, electrons are emitted from the cathode electrode 813 so that a current flows into anode electrode 811, resulting in production of the drive current Jd. Some of the electrons forming this current Jd do not flow into anode electrode 811, but instead flow into an acceleration electrode 122; such electrons become emission electrons 911. A current of the emission electrons becomes the emission current Je (the flow of emission current Je is opposite in direction to the flow of electrons as an electron is an electrical carrier of the negative polarity). In this case, the emission ratio Je/Jd is at a few to ten percent. In this way, in the matrix electron emitter display using the SCE elements as its electron emission elements, the current for driving an element becomes large in magnitude. It is thus needed to sufficiently increase the ability to feed current from electrode wires to element electrodes (corresponding to the anode and cathode electrodes 811 and 813, in this case).

An electron beam emitted from an electron emission element has a finite degree of spatial divergence. It is thus required to lessen or minimize the spatial divergence of such beam in order to further increase the image resolution of a high-definition/fine-pitch display apparatus.

Some currently available approaches to increasing the display image resolution are faced with a problem which is caused by the divergence of an electron beam emitted from an electron emission element. More specifically, as shown in FIG. 5, an electron beam 911 emitted from electron emission element 301 has a finite degree of spatial divergence. Accordingly, when the layout pitch of phosphors 114 of adjacent pixels on faceplate 110 is decreased to design a higher-resolution display, the electron beam can irradiate not only the phosphor 911 of a target pixel but also other phosphors 911 of its neighboring pixels as shown in FIG. 5. In this case, the neighboring pixels are excited to emit light although these are not the intended ones. In particular, in the case of a color image display apparatus, neighboring phosphors are different in luminescence color from each other. Thus, letting adjacent pixels emit light results in the color of a display image becoming different from the intended color. This causes appreciable degradation of display image quality, such as a decrease in color purity. Thus, it is needed to lessen the spatial divergence of electron beam in order to achieve an advanced high-definition image display apparatus with further increased image resolutions.

One approach to lessening the electron beam's spatial divergence in matrix electron emitter display apparatuses is to use a focus electrode, also known as a focusing electrode. The focusing electrode is used to constitute an electron lens for focusing an electron beam to thereby reduce the size of a beam spot on phosphor screen. However, the use of such focusing electrode accompanies penalties which follow: an increase in process complexities of display apparatus manufacturing methodology, and an increase in production costs.

JP-A-2007-48548 discloses therein a technique for designing a neighboring scan line to serve also as the focusing electrode to thereby achieve the electron beam focusing function in an image display apparatus. A cathode structure using this technique is shown in FIGS. 6A and 6B. FIG. 6A is a top plan view of the cathode, and FIG. 6B is its cross-sectional view as taken along line A-B of FIG. 6A. An electron emission element 301 corresponding to one pixel (sub-pixel in the case of a color display device) is electrically connected by a current-feeding electrode 305 to a scan line 310. This scan line extends in the horizontal direction in FIG. 6A. In this drawing, there are depicted only the shapes of scan lines 310, electron emission elements 301 and feeding electrodes 305 for electrical connection therebetween. Each scan line 310 has a protruded portion 315 (focus electrode), which is designed to extend along the right and left side edges of its associated electron emission element.

With such the arrangement, an electron beam emitted from electron emission element is focused inward due to electron lens effects by the protrusion 315 of scan line 310, resulting in a beam spot on phosphor screen becoming smaller in diameter. In short, the scan-line protrusion 315 functions as the focus electrode. Especially, as scanline protrusion 315 is placed on the right and left sides of its associated electron emission element, the beam is focused in the lateral direction. This contributes to achievement of higher image resolutions of color image display apparatuses.

Unfortunately, this prior art design suffers from a problem: it is impossible to enhance the ability to feed a current to electron emission elements as will be described in detail later, resulting in a decrease in reliability of electron emission elements. Another problem faced with the prior art is that the electron emission ratio (electron emission efficiency) is not increasable in a case where the electron emission elements are constituted from thin-film electron emitters.

### SUMMARY OF THE INVENTION

When attempts are made to perform the focusing of an emitted electron beam by using a neighboring scan line for achievement of higher image resolution of a matrix electron emitter display apparatus, the current feeding capability from a scan line to electron emission element becomes deficient. This deficiency in current feeding capability brings a bar to improvement of the electron emission efficiency. Another problem caused thereby is the risk of a decrease in reliability of the current feeding to the electron emission element.

It is therefore an object of this invention to provide an image display apparatus capable of enhancing the ability to supply a current from a feeding wire to top electrode while at the same time enhancing the focusing capability of an electron beam emitted.

A representative one of principal concepts of the invention as disclosed herein will be explained in brief below.

In an image display apparatus including a display panel having cathode and phosphor plates and a drive circuit, the cathode plate has a plurality of electron emission elements, a plurality of parallel scan lines, and a plurality of parallel data lines crossing at right angles to the scan lines. Each of the electron emission elements has a first electrode electrically connected via a feeding electrode to a corresponding one of the scan lines and a second electrode electrically connected to a corresponding one of the data lines. Each electron emission element has an electron emission area for emitting an electron upon application of a voltage between the first and second electrodes. The phosphor plate has a phosphor and an acceleration electrode for causing the emitted electron to excite the phosphor for light emission to thereby permit the image display apparatus to display an image. The feeding electrode is connected to one side of the scan line. A longer side of those sides forming the electron emission area is used as a feeding side connected to the feeding electrode. A focus electrode is provided at a position opposing the feeding electrode with the electron emission area being interposed therebetween. The focus electrode is connected to an adjacent scan line of the scan line.

As stated above, according to this invention, a protruded portion of neighboring scan line is provided along one of longer sides of an electron emission area for functioning as the focus electrode, while providing the feeding electrode along the other longer side of the electron emission area. Use of this arrangement improves the ability to feed current from the scan line. Thus, a distribution of drive current within an electron emission-element's electrode is dispersed to thereby improve the reliability of an electron emission element. Additionally, in the case of a thin-film electron emitter being used as an electron emission element, the improvement in current feeding capability enables the top electrode to decrease in thickness, thus increasing the electron emission efficiency.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are diagrams showing one example of a cathode structure of a display panel of an image display apparatus in accordance with an embodiment of this invention.

FIG. 2 is a diagram illustrating, in cross-section, a matrix electron source display apparatus.

FIG. 3 is a diagram for explanation of an electron emission mechanism of a thin-film electron emitter.

FIG. 4 is a diagram showing a structure of a surface-conduction electron emitter (SCE) element.

FIG. 5 is a diagram schematically showing the spatial divergence of an electron beam emitted.

FIGS. 6A and 6B are diagrams showing a cathode structure having a focus electrode.

FIGS. 7A to 7C are diagrams each showing one example of a sub-pixel structure in a color image display apparatus.

FIGS. 8A to 8C are diagrams schematically showing a voltage drop amount at a thin-film electron emitter corresponding to a single pixel of display panel.

FIG. 9 is a graph showing actual measurement data of an electron emission ratio in the case of this invention being applied.

FIGS. 10A and 10B are diagrams showing the definition of a feeding side at SCE element.

FIG. 11 is a diagram showing a plan view of a display panel structure of an image display apparatus also embodying the invention.

FIG. 12 is a diagram showing a cross-section of the display panel structure of the image display apparatus embodying the invention.

FIG. 13 is a plan view of part of a cathode plate of first embodiment of an image display apparatus embodying the invention.

FIGS. 14A and 14B are sectional views of the part of the cathode plate of first embodiment of the image display apparatus embodying the invention.

FIGS. 15A to 15C are diagrams for explanation of a fabrication process of the cathode plate of the first embodiment of the image display apparatus embodying the invention.

FIGS. 16A to 16C are diagrams for explanation of a fabrication process of the cathode plate of the first embodiment of the image display apparatus embodying the invention.

FIGS. 17A to 17C are diagrams for explanation of a fabrication process of the cathode plate of the first embodiment of the image display apparatus embodying the invention.

FIGS. 18A to 18C are diagrams for explanation of a fabrication process of the cathode plate of the first embodiment of the image display apparatus embodying the invention.

FIGS. 19A to 19C are diagrams for explanation of a fabrication process of the cathode plate of the first embodiment of the image display apparatus embodying the invention.

FIGS. 20A to 20C are diagrams for explanation of a fabrication process of the cathode plate of the first embodiment of the image display apparatus embodying the invention.

FIGS. 21A to 21C are diagrams for explanation of a fabrication process of the cathode plate of the first embodiment of the image display apparatus embodying the invention.

FIGS. 22A to 22C are diagrams for explanation of a fabrication process of the cathode plate of the first embodiment of the image display apparatus embodying the invention.

FIGS. 23A to 23C are diagrams for explanation of a fabrication process of the cathode plate of the first embodiment of the image display apparatus embodying the invention.

FIG. 24 is a diagram showing electrical connection between a display panel of first embodiment of the image display apparatus embodying the invention and its associated driving circuit.

FIG. 25 is a diagram showing waveforms of some major drive signals of the first embodiment of the image display apparatus embodying the invention.

FIG. 26 is a diagram showing waveforms of drive signals of an image display apparatus of another embodiment of the invention.

FIG. 27 is a plan view of part of a cathode plate of an image display apparatus in accordance with second embodiment of this invention.

FIGS. 28A and 28B are diagrams each showing a sectional view of part of the cathode plate of the image display apparatus in accordance with second embodiment of this invention.

FIGS. 29A and 29B are diagrams each showing a schematic representation of the trajectory of an electron beam in the image display apparatus in accordance with the second embodiment of this invention.

FIG. 30 is a plan view of part of a cathode plate of an image display apparatus in accordance with third embodiment of this invention.

FIG. 31 is a plan view of part of a cathode plate of an image display apparatus in accordance with fourth embodiment of this invention.

FIGS. 32A and 32B are diagrams each showing a sectional view of part of the cathode plate of the image display apparatus in accordance with the fourth embodiment of this invention.

FIG. 33 is a diagram showing waveforms of drive signals of the image display apparatus of the fourth embodiment of this invention.

FIGS. 34A to 34D are diagrams showing definitions of long and short sides of the electron emission area of this invention.

FIGS. 35A and 35B are diagrams showing the positional relationship of strip-shaped phosphor areas and electron emission areas.

### DETAILED DESCRIPTION OF THE INVENTION

Some image display apparatuses in accordance with the currently preferred embodiments of the present invention will be described in detail with reference to the accompanying drawings below.

### Embodiment 1

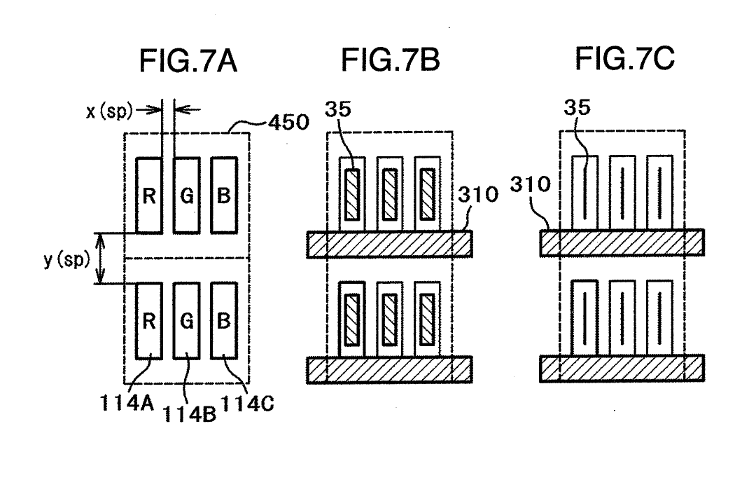

Embodiment 1 is an example of the case where this invention is applied to a metal-insulator-metal (MIM) electron emitter display or a surface-conduction electron-emitter display (SED) or the like. The beam focusing property required in the case of a color image display apparatus will be described. In the color image display apparatus, it is an ordinary way to configure a single pixel 450 by disposing three separate sub-pixels which yield red, green, and blue light rays, respectively, as shown in FIGS. 7A-7C. In a matrix electron emitter display, a red phosphor 114A, green phosphor 114B and blue phosphor 114C are formed in respective subpixels to thereby constitute a single pixel 450.

In the matrix electron emitter display, as shown in FIGS. 7A-7C, three subpixels are disposed in a direction along a scan line (in the horizontal direction in the illustrative example) to constitute a single pixel. In particular, in the case of a line-sequential drive technique, only one (or two scan lines) emits light at a time, the averaged brightness of emitted light is given by 1/Nscan (or 2/Nscan), where Nscan is the number of scan lines. More specifically, an increase in scan line number Nscan results in a decrease in brightness of display apparatus. Thus, it is preferable to dispose the subpixels along the scan line.

As each pixel is preferably designed to have a shape which is maximally similar to a square, the shape of each subpixel becomes a rectangular shape that extends in a direction at right angles to its associated scan line as shown in FIGS. 7A-7C. Accordingly, in many cases, the resulting relationship is given as y(sp)>x(sp), where x(sp) is the distance between adjacent subpixels in the horizontal direction, and y(sp) is the distance between adjacent subpixels in a vertical direction perpendicular thereto. Thus, it is a must to control the spatial divergence of an electron beam in such a way as to increase the focusing capability with respect to the scan-line direction (i.e., lateral direction). Furthermore, in the color image display apparatus, the adjacent subpixels in the scan-line direction are different from each other in color of emitted light; so, letting these adjacent pixels perform light emission induces unwanted color mixture, resulting in a decrease in image quality. From this viewpoint also, it is required to enhance the focusing capability of the electron beam with respect to the scanline direction (lateral direction).

FIG. 7B is a diagram schematically representing a layout pattern of electron emission areas 35 on a cathode plate and a layout of scan lines 310 associated therewith. In a way corresponding to the fact that the individual subpixel has a rectangular shape extending in the direction at right angles to the scan lines, each electron emission area 35 is designed to have a rectangular shape extending in the direction perpendicular to the scan lines 310. With such an arrangement, an electron beam emitted is expected to have a vertically elongated shape so that this beam shape is identical to the shape of a phosphor 114. This makes it possible to permit the phosphor 114 to perform excitation and light emission with increased efficiency.

In the case of the electron emission area having a line shape (i.e., slit-like shape), it may be considered that the length of a short side of the rectangular electron emission area becomes zero. In view of this, the layout of FIG. 7C is preferably employable. With this arrangement, the electron beam emitted has the elongate shape whereby this beam shape is identical to the shape of phosphor 114 so that the phosphor 114 is enabled to perform excitation and light emission with increased efficiency.

A summary of the discussion above is as follows. In the color image display apparatus, the subpixel shape becomes a rectangle having the longer sides extending in the direction at right angles to the scan lines: in the case of the scan lines being formed in the horizontal direction, the subpixel shape becomes vertically elongated. Consequently, the electron beam emitted is needed to have higher focusing ability in the horizontal direction. And, the shape of the electron emission area of the electron emission element corresponding to each subpixel also has a rectangle having the longer sides in the direction perpendicular to the scan lines.

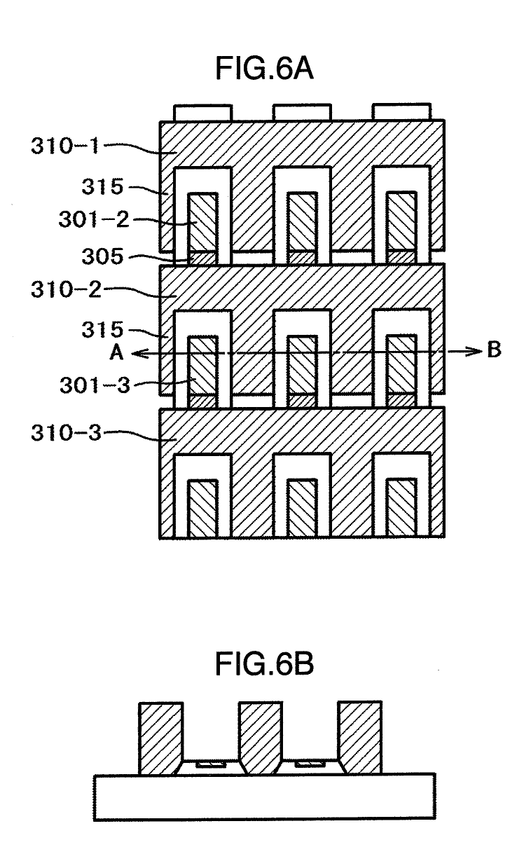

As previously stated, use of the cathode structure shown in FIGS. 6A and 6B makes it possible to focus the emitted electron beam in the horizontal direction. The technique for permitting the protruded portion 315 of a neighboring scan line to function also as the focusing electrode offers two advantages which follow: (1) the required electron beam focusing ability is attainable by mere change of the processed shape of scan lines, resulting in simplification of a fabrication process thereof; and (2) using the protrusion 315 of a neighboring scan line as the focusing electrode makes it possible to set the voltage potential of such focus electrode at a value which is different from a drive voltage being applied to a selected scan line, thereby enabling enhancement of the focusing capability of the electron beam.

Meanwhile, the neighboring scan-line protrusion 315 and the scan line 310 are formed in the same layer so that there are layout limits. When looking at an electron emission element 301-2, this electron emission element 301-2 is electrically connected to a scan line 310-2 by way of electrical feeding electrode 305. On the other hand, the electron emission element 301-2 has its right and left sides which are surrounded by protrusions 315 of its neighboring scan line 310-1. This is because protrusion 315 functions as the focus electrode for focusing the electron beam in the horizontal direction. As stated above, the right and left sides are identical to longer sides (long sides) of electron emission element 301-2. Therefore, the feeding electrode 305 is connectable only to one of the remaining, shorter sides (short sides) of electron emission element 301-2.

When connecting the feed electrode only at the short side of electron emission element 301, the resulting current feeding ability becomes deficient for the reason which follows. An explanation will be given by taking as an example a thin-film electron emitter which is comprised of a top electrode, a base electrode and an electron acceleration layer that is sandwiched between these electrodes. The ability to supply a current from a feed wire to the top electrode may be represented by a voltage potential drop amount between the feed wire and the top electrode. In short, the smaller the voltage drop amount, the higher the feeding ability. Consequently, approximate calculation of the voltage drop amount is performed.

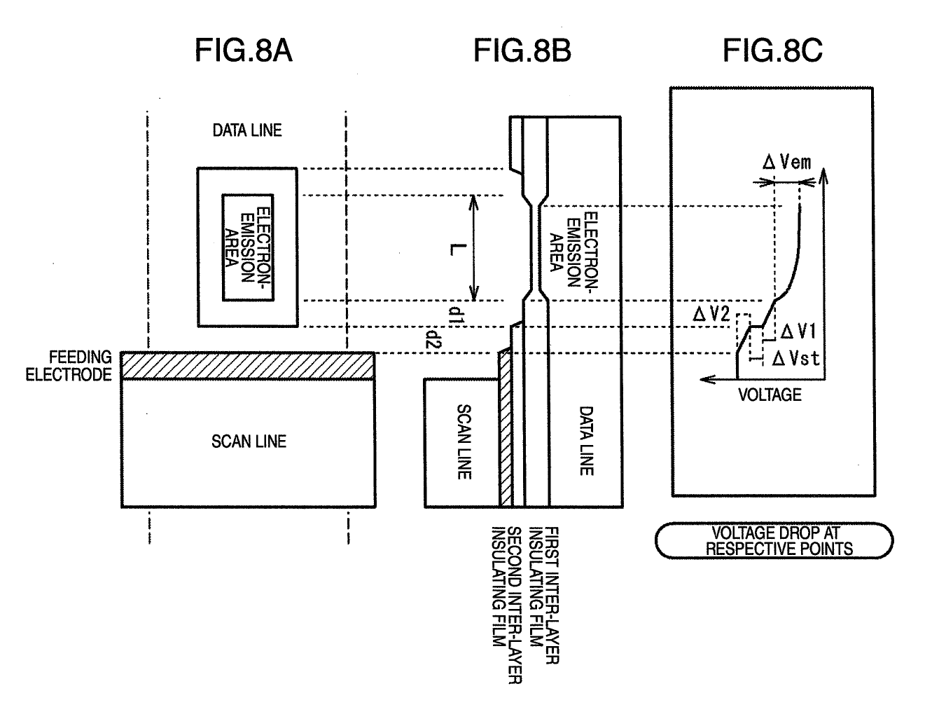

FIGS. 8A-8C are diagrams showing a structure of thin-film electron emitter of the prior known type. Shown herein is part of a matrix array of thin-film electron emitters, which corresponds to a single sub-pixel (i.e., an element corresponding to a one-color phosphor in a pixel). An electron emission area is formed at a location at which a scan line and a data line cross together (this location corresponds to one subpixel of image display apparatus). FIG. 8A is a top plan view, FIG. 8B is a cross-sectional view, and FIG. 8C is a diagram schematically showing a voltage drop amount during operation of a thin-film electron emitter.

Although not specifically shown in FIGS. 8A-8C, a top electrode is continuously formed at the uppermost layer to cover a range of from a feeding electrode up to the far end of electron emission area and is electrically connected thereto. Typically the top electrode has a thickness of about 1 nm to 20 nm. The feeding electrode is typically 10 nm to 500 nm in thickness. The top electrode is sufficiently less in sheet resistance p than the feeding electrode. Therefore, for estimation of the feeding capability, the amount of voltage drop between the contact electrode and the top electrode on the farthest end of the electron-emission area should be calculated.

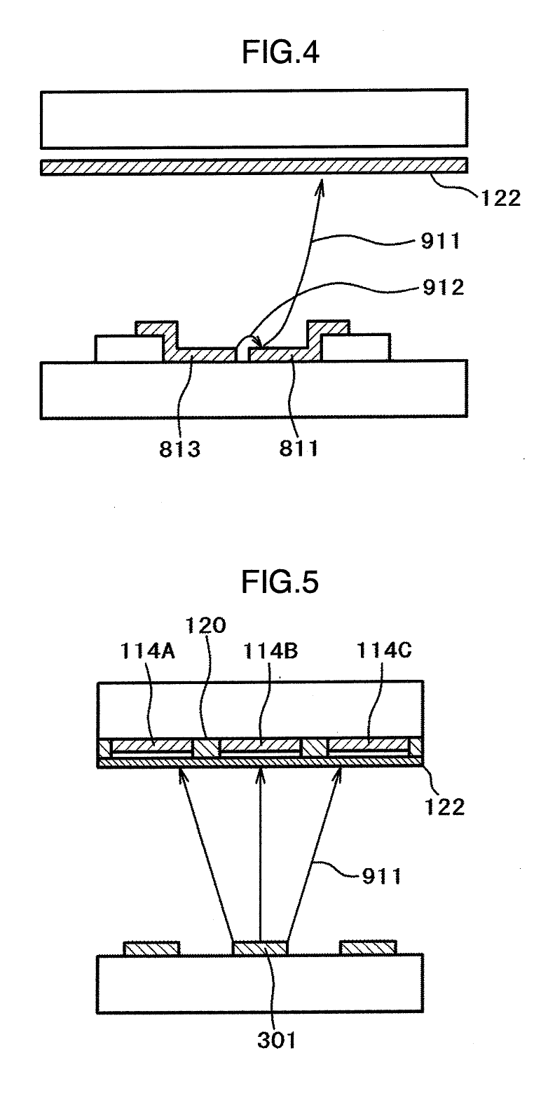

FIG. 8C is a diagram schematically showing the amount of voltage drop during operation. It is assumed that voltage drop on the second inter-layer insulating film (length d2) is ΔV2, voltage drop at the edge (step) of the second inter-layer insulator is ΔVst, voltage drop on the first inter-layer insulating film (length d1) is ΔV1, and voltage drop at the electron-emission area (length L) is ΔVem. In the electron-emission area, since a current flows between the top electrode and the base electrode, a current flowing in the top electrode differs depending on places, as shown in FIG. 4C, and a curved line of voltage drop becomes closer to parabolic. To simplify formulation, the diode current density inside the electron-emission area is approximated with a constant value (=J) inside the electron-emission area. Assuming that a position x inside the electron-emission area is a distance from the feed side, voltage drop ΔVem(x) at the place x can be expressed by formula below:

$$Δ {V}_{em} ( x ) = ρ {JL}^{2} ( β - \frac{{β}^{2}}{2} ) , β = \frac{x}{L} \qquad ( Eq . 1 )$$

In Equation (1) above, L is the length of electron emission area, and ρ is the sheet resistance of top electrode (FIGS. 8A-8C). Therefore, the voltage drop at the far end (x=L) of electron emission area, ΔVem=ΔVem(x=L), can be expressed by formula below:

$$Δ {V}_{em} = Δ {V}_{em} ( x = L ) = \frac{1}{2} ρ {JL}^{2} \qquad ( Eq . 2 )$$

Now, a “feeding side” is defined for the electron emission area. A feeding side is defined as a side among those sides making up the electron emission area, which functions as a current feed path from a busline electrode to the top electrode overlying the electron emission area. As previously stated, in the calculation of the voltage drop on a current feed path, the voltage drop along the feeding electrode is negligible in many cases when compared to the voltage drop at the top electrode; therefore, a feeding side can also be defined as a side that functions as a current feed path from a feeding electrode to the top electrode over the electron emission area. Accordingly, from a viewpoint of the structure, “a feeding side” is defined as a side of those sides making up the electron emission area, along which side the feeding electrode extends.

Let the length of the shorter side (short side) of the electron emission area be given as “a”; let “b” be the length of the longer side (long side) thereof. In the color image display apparatus, the ratio of the longer side to the shorter side of the subpixel shape is typically three (3) as stated supra, so it is reasonable to assume that the radio b/a is 3 as a typical example. In the case of a current being fed through the shorter side, L is equal to b (L=b); In the case of the current being fed through the longer side, L=a. Thus, as apparent from Equation (2), the amount of voltage drop in case a current is supplied from the longer side becomes nine times less than that in the case of a current being fed through the shorter side. This means that the current feeding ability is nine-fold superior in the case of a current being fed through the longer side.

In order to apply a constant voltage over the entire electron emission area, it is required to reduce the voltage drop ΔVem less than or equal to a predetermined value. If we adopt a wiring structure in which current is fed through the longer side, thereby L=a=b/3, then a higher sheet resistance ρ is acceptable for the top electrode to keep ΔVem less than a predetermined value. In this way, it is possible to reduce or minimize the thickness of the top electrode.

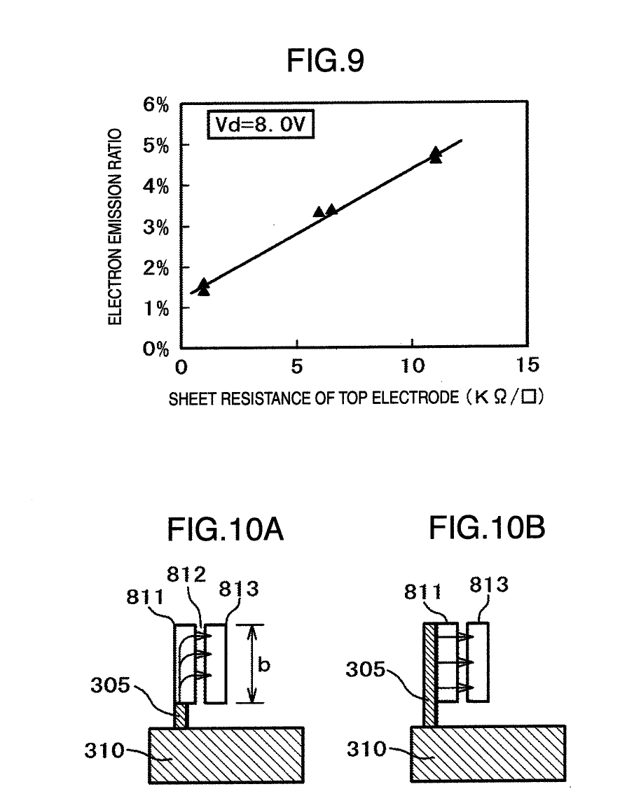

As apparent from an electron emission mechanism shown in FIG. 3, a decrease in film thickness of the top electrode results in a likewise decrease in scattering within the top electrode, which in turn leads to a decrease in energy loss that “hot” electrons lose by such scattering. Thus, the electron emission efficiency increases. FIG. 9 is a graph showing measurement results of the electron emission efficiency of a thin-film electron emitter which was designed to increase in current feeding ability by use of the technique for feeding a current through the longer side(s) of an electron emission area, and thereby reducing the film thickness of top electrode. The top electrode thickness is indicated by the sheet resistance of the top electrode in this graph. From this graph, it can be seen that the electron emission efficiency increases with a decrease in thickness of the top electrode.

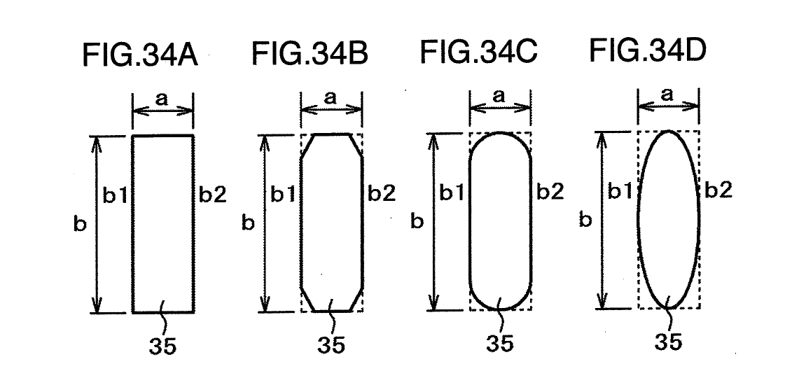

In this way, feeding a current through the longer side(s) of electron emission area makes it possible to enhance the current feeding ability to thereby improve the electron emission efficiency. In cases where the “longer side” and “shorter side” of electron emission area are stated in this specification, the shape of electron emission area should not exclusively be limited to the rigorous rectangle only. The terms “longer side” and “shorter side” of electron emission area as used herein may also include a “longer side” and “shorter side” of a rectangular shape which is constituted from major sides that form the electron emission area; or a “longer side” and “shorter side” of a rectangle which is in contact with the electron emission area and surrounds it. Various examples of the electron emission area 35 are shown in FIGS. 34A to 34D. In the example of FIG. 34A, a side “b” becomes the long side, and a side “a” is the short side. In the case of an electron emission area 35 having its shape indicated by solid lines in FIGS. 34B-34D, a virtual rectangle indicated by dotted lines are considered, wherein respective sides b are called the long sides whereas sides a are called the short sides.

In FIGS. 34A-34D, a long side b2 with respect to a long side b1 is called the “side that opposes the long side b1.” Incidentally, a total current flowing over the electron emission area whose length is L (FIGS. 8A-8C) is concentrated at the feeding electrode side of the top electrode. Therefore, feeding a current from the longer side of electron emission area results in a decrease in amount of a current flow per unit volume of the top electrode, thereby improving the reliability of such electrode. In the thin-film electron emitter, (a) the drive current (diode current) is at least four times greater than the emission current, and (b) the top electrode is as thin as several nm to 10 nm. Thus, it is important for the reliability improvement to lower the current flowing per unit volume.

In the case of a surface-conduction electron emitter (SCE) element also, (a) the drive current (diode current) is at least four times greater than the emission current, and (b) any one of a cathode electrode and an anode electrode, which is connected to the feeding electrode, is as thin as several nm to 10 nm. It is thus important to lower the current flowing per unit volume in the anode electrode or cathode electrode in a viewpoint of the reliability. Thus, in the SCE element also, it is effective for the reliability improvement to connect the feeding electrode to the longer side of electron emission area.

The “longer side” of an electron emission unit in the SCE element will be described below. As previously stated in conjunction with FIG. 4, the SCE element is arranged so that an electron emission gap 812 with a width of several nm to tens of nm is provided between a anode electrode 811 and a cathode electrode 813, for permitting a drive current to flow in this electron emission gap 812. Plan views are schematically shown in FIGS. 10A and 10B. In this case, the electron emission gap 812 should be regarded as the electron emission area. More specifically, as shown in FIGS. 10A and 10B, the length b of electron emission gap 812 is equivalent in structure to the “long side” of electron emission area whereas the gap width of electron release gap 812 corresponds to the short side a. In FIGS. 10A and 10B, the flow path of a drive current is indicated by arrows. When comparing the arrangements of FIGS. 10A and 10B, it can be seen that the drive current hardly exhibits concentration in the arrangement of FIG. 10B in which the feeding electrode 315 is provided along the longer side of electron emission gap 812.

As stated above, when providing the feeding electrode along the longer side of electron emission area of electron emission element, the current feeding ability is improved. This is effective for improvement of the reliability of the electron emission element. Alternatively, in the case of the thin-film electron emitter, the improvement in current feeding ability is also effective for improving the electron emission efficiency. It is noted here that it is needed to provide the protruded part of scan line along the longer side of electron emission unit in order to achieve successful focusing of an emitted electron beam as has been described previously. In this way, with the prior known methodology, it is impossible to satisfy both the requirement for improvement of the focusing capability of an emitted electron beam and the requirement for improving the ability to feed a current to an electron emission element at the same time. The present invention avoids the problems faced with the prior art and provides a new and improved image display apparatus capable of improving the electron beam focusing ability while at the same time improving the current feeding ability to electron emission elements.

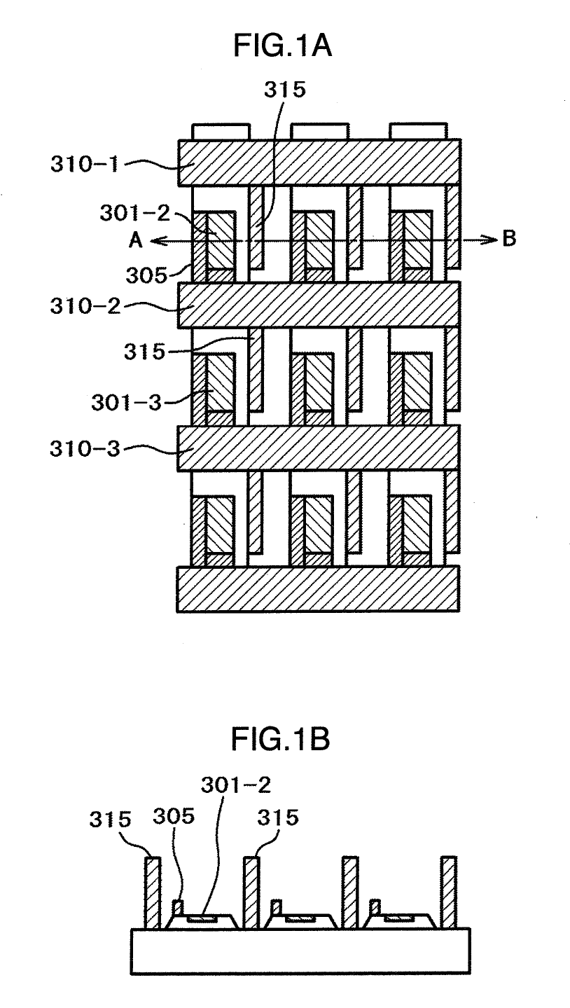

An embodiment of the invention will be described with reference to FIGS. 1A and 1B. FIG. 1A is a top plan view of a cathode plate as used in the embodiment. When looking at an electron emission unit 301-2, (1) a current feeding electrode 305 is provided along a one longer side of electron emission unit 301-2, and (2) a protrusion 315 (focus electrode) of scan line is provided so that it extends along the other longer side. With the arrangement (1), the current feeding ability increases for the reason stated supra. FIG. 1B illustrates a cross-section of the structure as taken along line A-B of FIG. 1A. As shown in FIG. 1B, the scan-line protrusion 315 is increased in thickness, for forming an electron lens in combination with a voltage to be applied to an acceleration electrode 122 (not shown in FIGS. 1A-1B). Whereby, an electron beam that is emitted from electron emission element 301 is focused onto a phosphor screen, resulting in a beam spot with a reduced diameter being formed thereon.

Also importantly, the scan-line protrusion 315 making up the electron lens is connected to scan line 301-1. Electron emission element 301-2 is connected via feeding electrode 305 to scan line 301-2. Thus it is possible to set the protrusion 315 making up the focus electrode and the electron emission element 301 at different potential levels. Accordingly, by setting to an adequate potential relation, it is possible to optimize the focusing property of the electron beam.

### Embodiment 2

In this embodiment 2, a practical arrangement of an image display apparatus using metal-insulator-metal (MIM) electron emitter also incorporating the principles of this invention will be described.

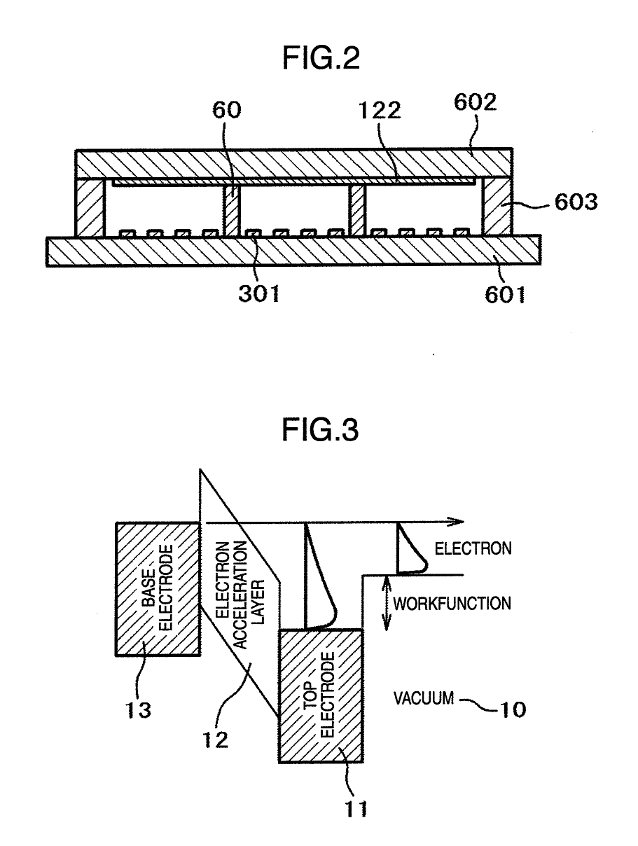

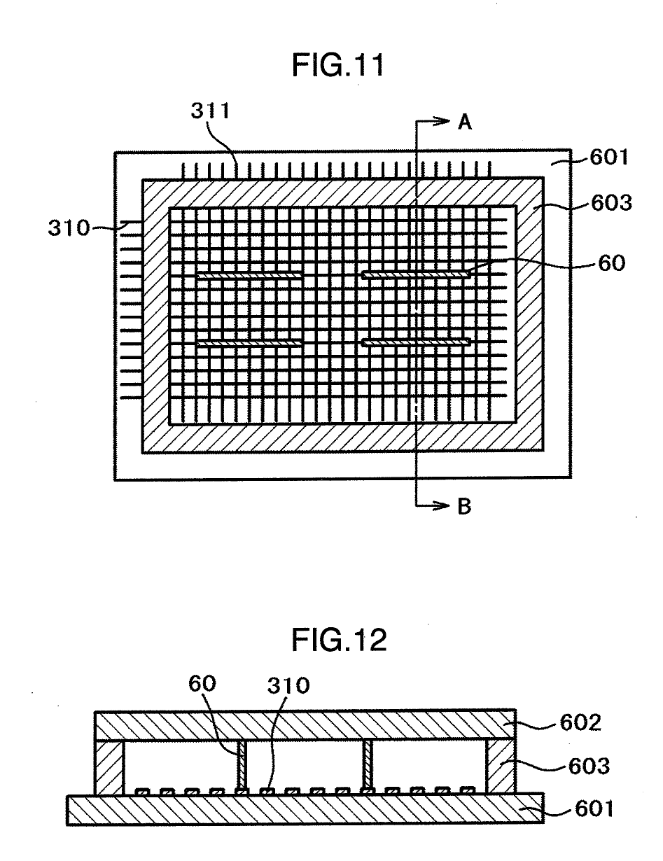

FIG. 11 is a top plan view of a display panel used in this embodiment. FIG. 12 is a cross-sectional view of the panel as taken along line A-B of FIG. 11. In FIG. 12, only scan electrodes 310 which are taken out of those constituent components of a cathode plate 601 are depicted for purposes of convenience in illustration herein. (On the contrary, in FIG. 2, only the electron emission elements 301 of the components making up the cathode plate 601 are depicted.)

An inside space that is surrounded by the cathode plate 601, a phosphor plate 602 and a frame component 603 is evacuated to a vacuum. In this vacuum region, one or more spacers 60 are disposed in order to provide increased durability against atmospheric pressures. The spacers 60 are designable and modifiable in shape, number and layout on a case-by-case basis. Although in FIG. 11 the thickness of spacer 60 is depicted to be larger than the width of scan electrode 310, this is for illustration purposes only: in reality, the thickness of spacer 60 is less than the width of scan electrode 310. Scan electrodes 310 are disposed on the cathode plate 601 in the horizontal direction, and data electrodes 311 are laid out in a direction at right angles thereto. Respective cross-points or “intersections” between scan electrodes 310 and data electrodes 311 correspond to pixels. Note here that the pixels correspond to sub-pixels in the case of a color image display apparatus.

Although only fourteen (14) scan electrodes 310 are depicted in FIG. 11, there are several hundreds to several thousands of lines in an actually implemented display apparatus. Regarding the data electrodes 311 also, several hundreds to thousands of lines are provided in the actually implemented display. Electron emission elements 301 are disposed at the intersections of scan electrodes 310 and data electrodes 311.

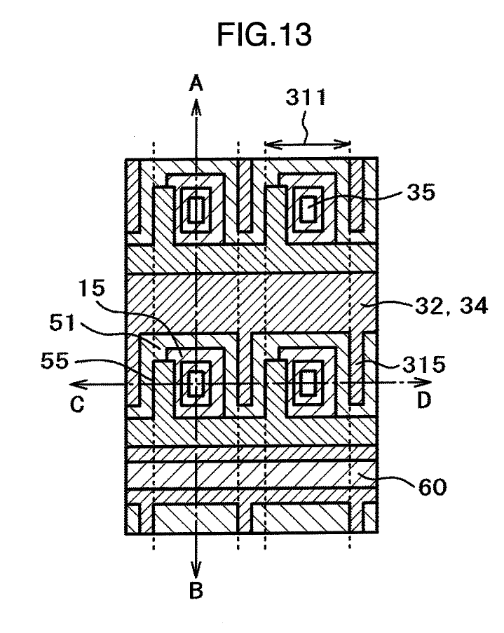

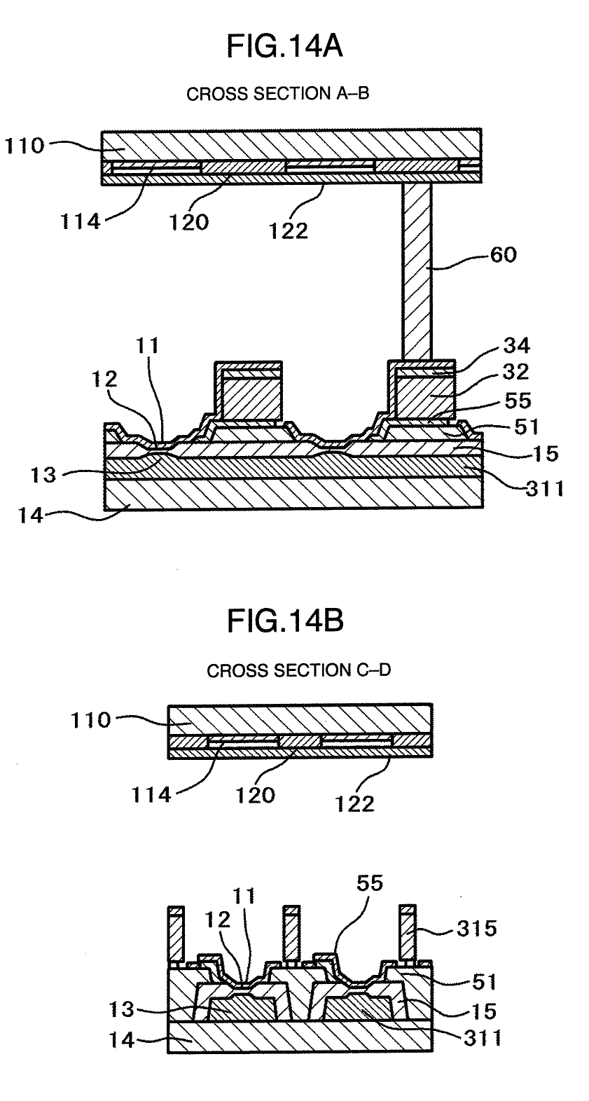

FIG. 13 is a plan view of part of the cathode plate 601 shown in FIG. 11, which corresponds to four adjacent subpixels. FIGS. 14A and 14B are sectional views of the part of cathode plate 601 in a way corresponding to that shown in FIG. 13. FIG. 14A is a sectional view as taken along line A-B of FIG. 13, whereas FIG. 14B is a sectional view along line C-D of FIG. 13. Note that, in the plan view of FIG. 13, a top electrode 11 is removed away for an illustrative purpose. In reality, as apparent from FIG. 14B, a film for use as the top electrode 11 is formed to cover an entire surface.

FIG. 13 shows details of a practical embodiment in the case of using a thin-film electron emitter as the individual electron emission element 301 in FIGS. 1A and 1B. Accordingly, in FIG. 13, the connection relationship of electron emission elements 301 and their associated electrode wiring is in the form corresponding to that shown in FIGS. 1A-1B. More specifically, describing using reference numerals of FIGS. 1A-1B, a current is fed from the scan line 310-2 to electron emission element 301-2 via feeding electrode 305 (corresponding to a contact electrode 55 in FIG. 13). From its adjacent scan line 310-1, a scan-line protrusion 315 is disposed along the longer side of an electron emission area (35 of FIG. 13). Scan line 310-1 in FIG. 1A corresponds to busline electrode 32 in FIG. 13. As previously stated, the adjacent scanline protrusion 315 is for use as the focus electrode.

An arrangement of the cathode plate 601 is as follows. In FIGS. 14A and 14B, a thin-film electron emitter 301 which is made up of a top electrode 11, insulator 12 and base electrode 13 (i.e., the electron emission element 301 in this embodiment) is arranged on an electrically insulative substrate 14, such as a glass plate. A busline electrode 32 is electrically connected via contact electrode 55 to top electrode 11. Busline electrode 32 functions as a current feeding line for feeding a current to top electrode 11. In other words, it functions to carry a current from a drive circuit up to the position of this subpixel. In this embodiment, busline electrode 32 serves as scan electrode 310.

In this embodiment, a thin-film electron emitter is used as the electron emission element 301. As shown in FIGS. 14A and 14B, the three components—i.e., base electrode 13, tunneling insulator 12 and top electrode 11—are fundamental parts of such thin-film electron emitter. An electron emission area 35 of FIG. 13 is the location that corresponds to the tunnel insulator 12. Electrons are emitted into the vacuum from the surface of top electrode 11 of electron emission area 35.

In this embodiment, some part of data line 311 (region in contact with tunnel insulator 12) works as the base electrode 13. In this specification, the part of the data line 311 which is in contact with tunnel insulator 12 will be referred to as base electrode 13. In FIG. 13, a triple or “three-fold” rectangle is depicted at a corresponding position of each subpixel. The innermost rectangular region indicates electron emission area 35, which is structurally equivalent to the innermost circumference of a tapered portion of first inter-layer insulating film 15. Its outer rectangle is equivalent to the outermost circumference of a tapered film of first inter-layer insulating film 15. Its outside (the outermost one of the three-fold rectangles) is an opening of second inter-layer insulating film 51.

In this embodiment, the scan electrode 310 is constituted from busline electrode 32. In addition, in this embodiment, one or more spacers 60 are provided on scan electrode 310. These spacers 60 are not needed to be disposed on all of the scan electrodes involved and may be placed at intervals, e.g., one spacer is for more than two scan electrodes. Spacers 60 are electrically connected to scan electrodes 310, for functioning to flow a current via spacer(s) 60 from acceleration electrode 122 of phosphor plate 602 and also functioning to flow electrical charges that are charged on spacers 60. Note that the scale in the height direction is arbitrary. More specifically, base electrode 13 and top electrode 11 are designed to be less than or equal to several μm whereas a distance between substrate 14 and face plate 110 is set to have a length of about 1 to 3 mm.

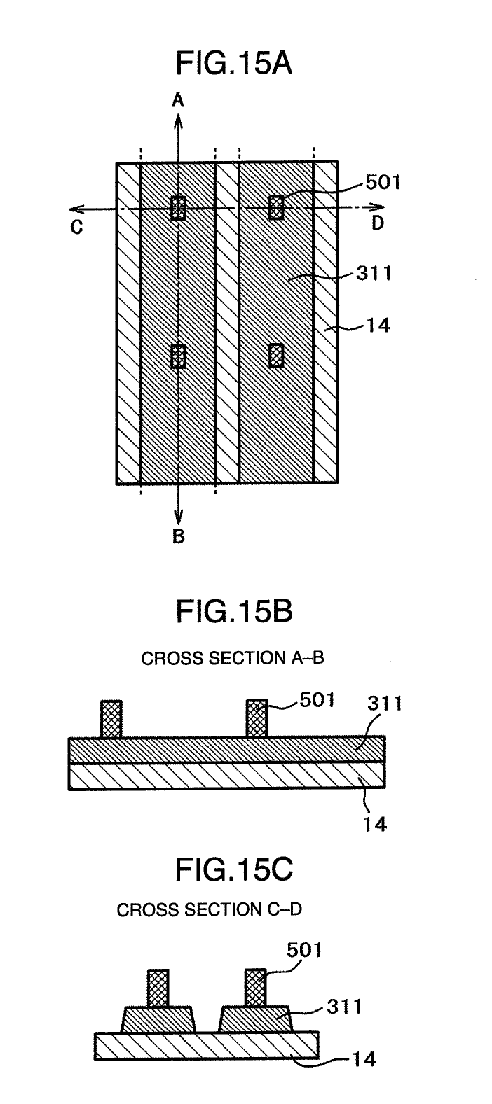

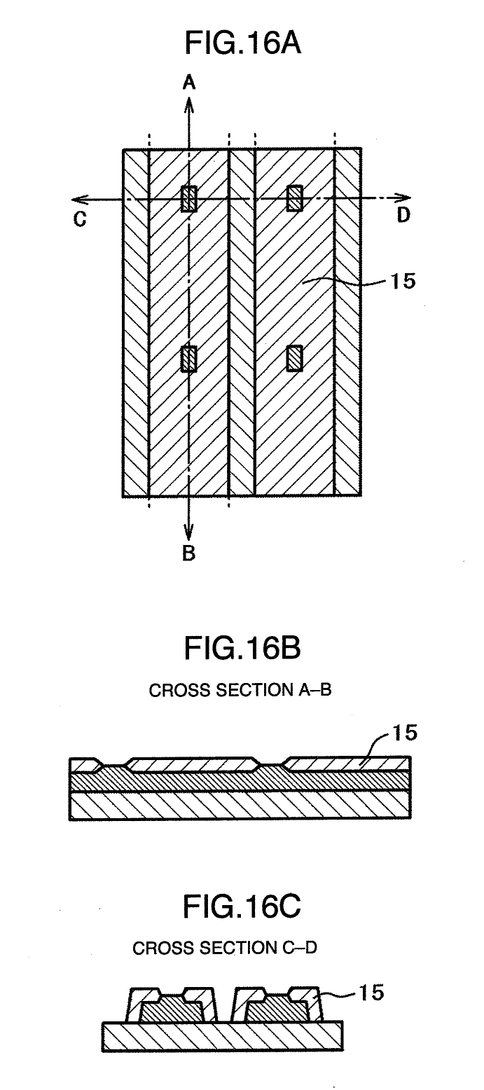

A method for fabricating the cathode plate 601 will be described with reference to FIGS. 15A-15C through 23A-23C. FIGS. 15A-23C are diagrams showing a process of fabricating thin-film electron emitters on substrate 14. In these diagrams, thin-film electron emitters corresponding to two-by-two subpixels are depicted. FIGS. 15A, 16A, . . . , 23A are plan views. Respective cross-sections as taken along line A-B are shown in FIGS. 15B, 16B, . . . , 23B. Sectional views along line C-D are shown in FIGS. 15C, 16C, . . . , 23C.

On the insulative substrate 14 such as a glass plate for example, a material for use as base electrode 13 (data lines 311), such as an aluminum (Al) alloy, is formed to a thickness of 300 nm. An example of the material used here is aluminum-neodymium (Al—Nd) alloy. This Al alloy film is formed by sputtering or resistive-heating evaporation techniques. Then, the Al alloy film is patterned into stripe-form through photolithographic resist formation and its subsequent etching, thereby forming base electrodes 13. The resist material used here may be the one that is suitable for the etching. This etching may be wet or dry etching.

Next, a resist film is coated and then subjected to ultraviolet-ray (UV) exposure for patterning, thereby forming a resist pattern 501 shown in FIGS. 15A-15C. An example of this resist is a quinonediazide-based positive resist. Next, anodic oxidation is performed while letting the resist pattern 501 be unremoved to thereby form first inter-layer insulating film 15. In this embodiment, the anodization was done with a anodization voltage of about 100V to form first inter-layer insulating film 15 with a thickness of about 140 nm. Thereafter, the resist pattern 501 is etched away. The resulting device structure is shown in FIGS. 16A-16C.

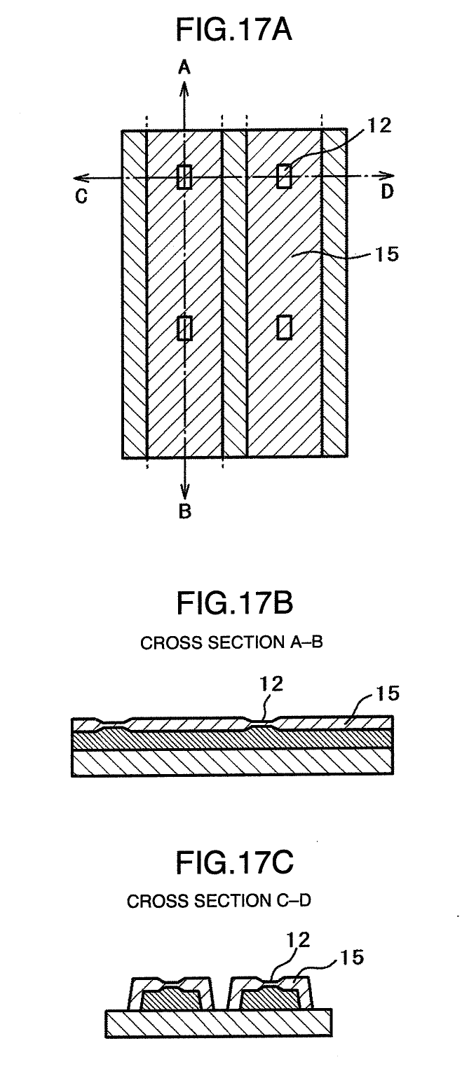

Next, anodic oxidization is applied to the surfaces of base electrodes 13 which had been covered with the resist 501 to thereby form a insulator 12. In this embodiment, the anodization voltage was set to 6V, and the insulator film thickness was set at 10.6 nm. The resultant structure is shown in FIGS. 17A-17C. A surface area with insulator 12 formed thereon becomes the electron emission area 35. In other words, a region surrounded by first inter-layer insulating film 15 is electron emission area 35.

It has conventionally been reported that the thickness d of an anodized insulator film obtained through anodization of aluminum is given as: d (nm)=1.36×VAO, where VAO is the anodization voltage. According to recent studies made by the inventors of the invention as disclosed and claimed herein, it was revealed that d (nm)=1.36×(VAO+1.8) when the film thickness is less than about 20 nm, as disclosed in IEEE Transactions on Electron Devices, Vol. 49, No. 6, pp. 1059-1065 (2002). The above-noted value (i.e., insulator film thickness of 10.6 nm at anodization voltage of 6V) was the value that was obtained from this latest version of relational equation.

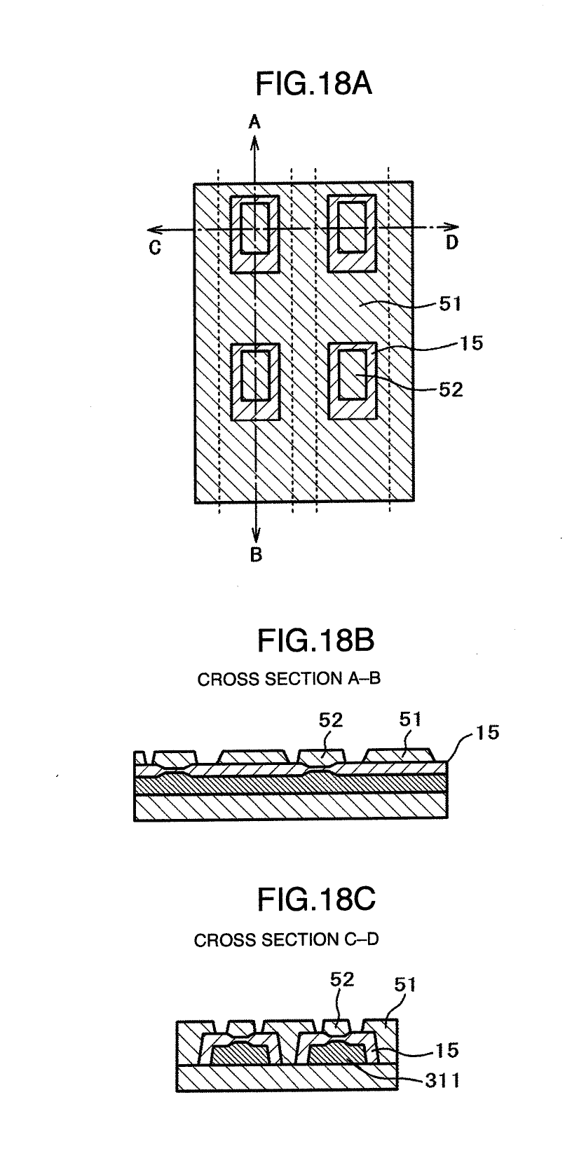

Next, with the following procedures, the second inter-layer insulating film 51 and an electron-emission area protection layer 52 are formed (FIGS. 18A to 18C). The pattern of the second inter-layer insulating film 51 is a pattern that covers an intersection area between the busline electrode 32 and the data electrode 311, and exposes the electron-emission area 35. However, in process steps of FIGS. 18A to 18C, the electron-emission area 35 is covered by the electron-emission area protection layer 52. The second inter-layer insulator 51 and the electron-emission area protection layer 52 are patterned by etching after silicon nitride SiNx, silicon oxide SiOx, or the like is deposited. In this example, a film of silicon nitride with a film the thickness of 100 nm is used. Etching is performed by dry etching which employs, for example, an etchant mainly composed of CF4 or SF6.

The second inter-layer insulating film 51 is formed to improve the insulation property between the scan electrode and the data electrode. The electron-emission area protection layer 52 is provided for the purpose of protecting a portion serving as the electron-emission area 35 (that is, the insulator 12) from process damage in the following processes; the electron-emission area protection layer 52 will be removed in a subsequent process as described later. In this example, the second inter-layer insulating film 51 and the electron-emission area protection layer 52 are formed of the same material in the same process step.

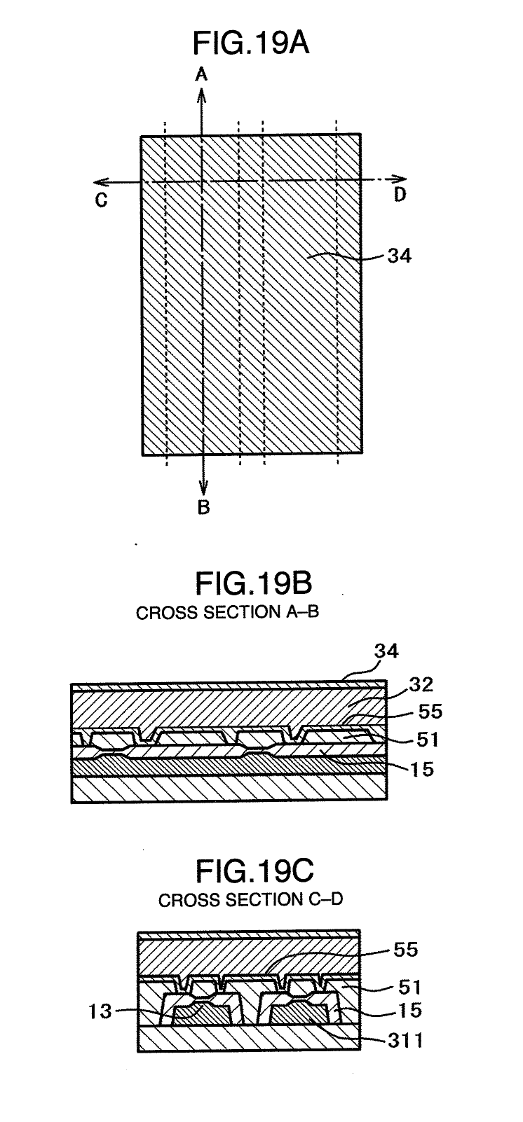

Next, as shown in FIGS. 19A-19C, films of chosen materials for constituting a contact electrode 55, busline electrode 32 and busline electrode upper layer 34 are formed in this order of sequence. In this embodiment, contact electrode 55 is made of chromium (Cr) having a thickness of 100 nm. Busline electrode 32 is made of aluminum (Al) with a thickness of 2 μm. Busline electrode upper layer 34 is made of Cr of 200-nm thick. These electrodes were formed by sputtering. Preferably a material that is relatively high in electrical conductivity is used for busline electrode 32, because the use of such material makes it possible to lower the voltage drop at this electrode.

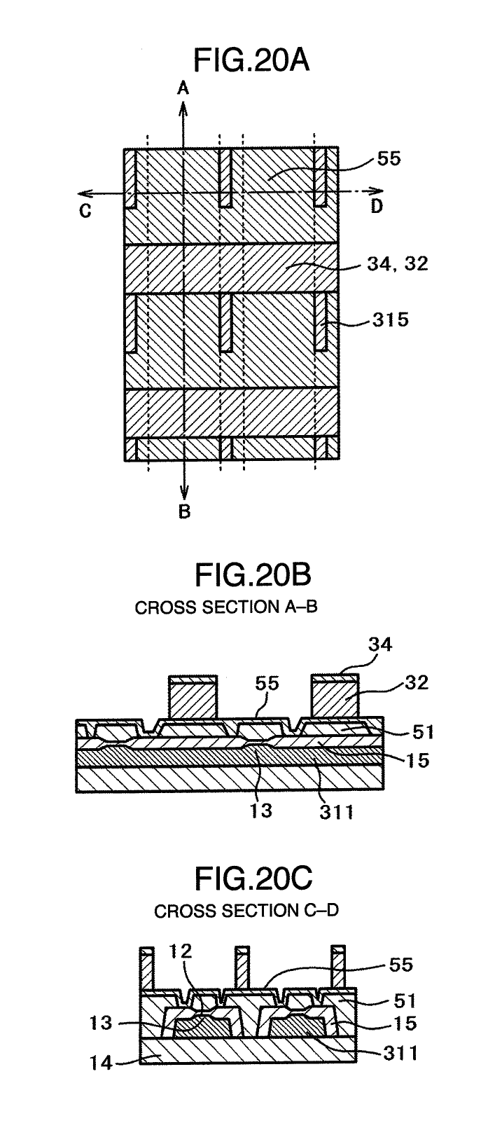

Next, the busline electrode upper layer 34 and the busline electrode 32 are patterned by etching, thereby, the contact electrode 55 is exposed so that the top electrode 11 can be connected to the contact electrode 55 later, thereby forming the busline electrode 32 (FIGS. 20B and 20C).

At this step, scan-line protrusion 315 is formed simultaneously. As better shown in FIGS. 20A and 20C, the use of a pattern with protrusion being provided at busline electrode 32 permits each protrusion to be used as the scan-line protrusion 315. More specifically, busline electrode 32 and scanline protrusion 315 are made of the same material. With this design, it is possible to fabricate the intended structure by known manufacturing processes.

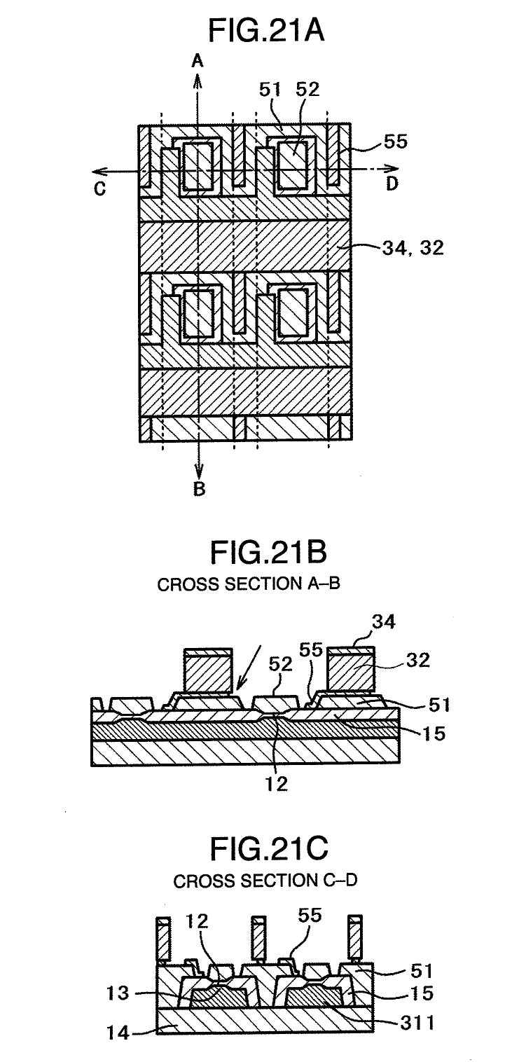

Next, as shown in FIGS. 21A-21C, the contact electrode 55 is patterned by etching. By this patterning of contact electrode 55, a current feeding ability from contact electrode 55 to electron emission area 35 is determined. As shown in FIG. 21A, contact electrode 55 is patterned so that two of the four sides of electron emission area 35 including a longer side extend therealong. With this current feeding structure using two sides of electron emission area 35 including the longer side, the current feeding ability is improved as stated supra.

As indicated by an arrow in FIG. 21B, for one side of the contact electrode 55 (a portion indicated by the arrow in this drawing), an undercut portion is formed with respect to the busline electrode 32. This undercut is for formation of an overhang for electrical isolation of top electrode 13 at a later step. Due to the presence of this undercut, top electrodes of subpixels which are connected to neighboring scan lines are electrically separated (isolated) from each other. This is called the “electrical separation between electron emission elements”. As busline electrode 32 and scan-line protrusion 315 are formed by the same process, an undercut is formed at a portion beneath scan electrode 315 also, which is electrically isolated from its neighboring scan line.

The degree of the undercut of contact electrode 55 is controllable in a way which follows. A portion which is to be formed into the undercut is obtainable by etching contact electrode 55 with a side of bus electrode 32 being used as a photomask therefore. Accordingly, contact electrode 55 is such that an undercut is created for busline electrode 32. On the contrary, if the amount of the undercut is too large, bus electrode 32 can collapse whereby undesired contact takes place between bus electrode 32 and second inter-layer insulating film 51 so that no overhang remains. To prevent formation of an extra-large undercut, a specific kind of material that is nobler in standard electrode potential than the material of busline electrode 32 is used as the material of contact electrode 55. In short, contact electrode 55 is made of a chosen material which is higher in standard electrode potential than the material of busline electrode 32.

When the busline electrode is formed of aluminum, an example of such a material includes: for example, chromium (Cr), molybdenum (Mo), a Cr alloy, or an alloy including these elements as components, such as a molybdenum (Mo)-chromium (Cr)-nickel (Ni) alloy including as components, for example. Embodiments of the alloy include: a Mo—Cr—Ni alloy, and the like. Such a combination causes side etching of the contact electrode 55 to stop in the course of process due to local cell mechanism, thus preventing an excessive increase in the amount of undercut. Further, since the busline electrode is a material with a less noble (low) standard electrode potential, the local cell mechanism can be controlled by controlling the area of the busline electrode, the area of which is exposed to an etching reagent; thereby, it is possible to control the stop position (that is, the amount of undercut) of the side etching of the contact electrode 55. To this end, the busline electrode upper layer 34 of chromium (Cr) is formed.

As apparent from the foregoing description, the contact electrode 55 is preferably made of the specific material that is nobler (higher) in standard electrode potential than the material of bus electrode 32.

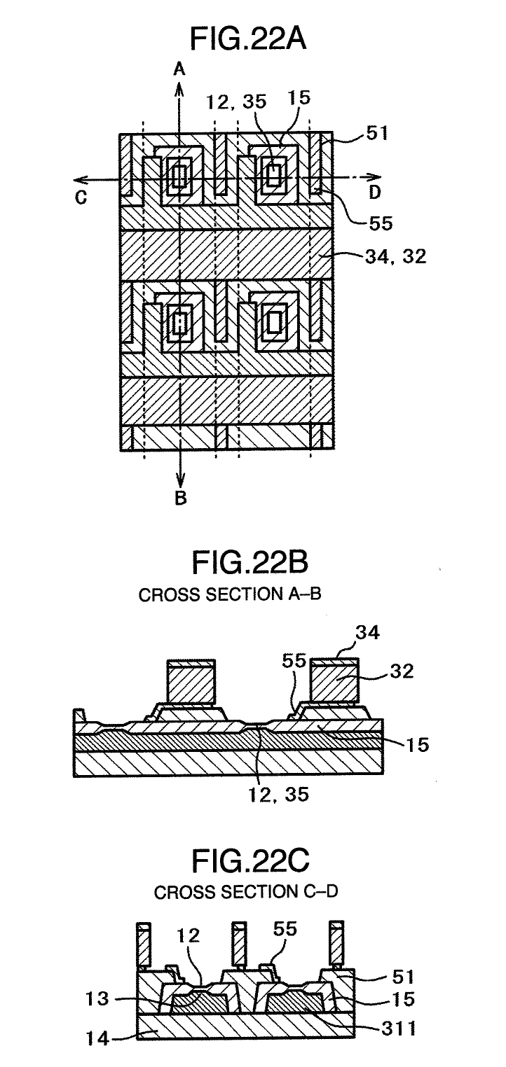

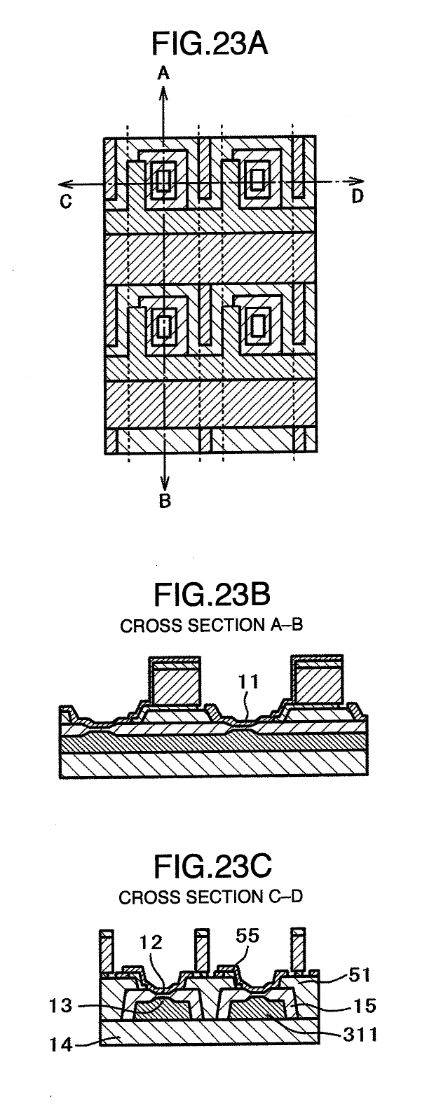

Next, as shown in FIG. 22A-22C, the electron emission area protection layer 52 is removed by dry etching or like etch techniques. Then as shown in FIGS. 23A-23C, top electrode 11 is formed, resulting in completion of cathode plate 601. In this embodiment, a multilayer film of iridium (Ir), platinum (Pt), and gold (Au) was used as the top electrode 11. Top electrode 11 was formed by sputtering. It should be noted that although top electrode 11 was actually formed to cover the entire surface, a diagram with the top electrode being removed away is shown in FIG. 23A for purposes of convenience in illustration. Additionally, positions of data lines 311 are indicated by dotted lines.

As shown in FIGS. 23A-23C, a current is supplied from the busline electrode 32 for use as a current feeding line to the top electrode 11 of electron emission area 35 via contact electrode 55. On the other hand, an appropriate degree of undercut is formed in contact electrode 55 in the way stated supra so that neighboring scan lines 310 are electrically insulated from each other.

This embodiment employs the cathode structure having two major features which follow: two sides including a longer side of the electron emission area is used as a current feed path extending from bus electrode 32 to top electrode 11 of electron emission area 35 (feature A); and, any step-like portions of second inter-layer insulating film are eliminated from the feed path from the bus electrode to top electrode of electron emission area (feature B).

The phosphor plate 62 is arranged in a way which follows. As shown in FIGS. 14A and 14B, an optically transparent faceplate 10 made of glass has a surface on which a black matrix 120 is formed. Furthermore, phosphor 114 is formed at a position opposing each electron emission area. In the case of the color image display apparatus, three primary colors—here, red, green and blue—of phosphors are coated or “painted” as phosphors 114 at different surface positions. Further, acceleration electrode 122 is formed. Acceleration electrode 122 is formed of an aluminum (Al) film with a thickness of about 70 nm to 100 nm. Electrons emitted from thin-film electron emitter 301 are accelerated by an acceleration voltage being applied to acceleration electrode 122 and then enter to acceleration electrode 122. These electrons pass through this acceleration electrode to collide with phosphor 114, causing the phosphor to emit light. A fabrication method of phosphor plate 602 is disclosed in detail in JP-A-2001-83907, for example.

An adequate number of spacers 60 are laid out between the cathode plate 601 and phosphor plate 602. As shown in FIG. 11, cathode plate 601 and phosphor plate 602 are air-tightly sealed together, with a frame component 603 being interposed therebetween. Furthermore, the inside space surrounded by cathode plate 601, phosphor plate 602 and frame component 603 is evacuated to a vacuum. With the above-stated procedure, the image display apparatus is completed.

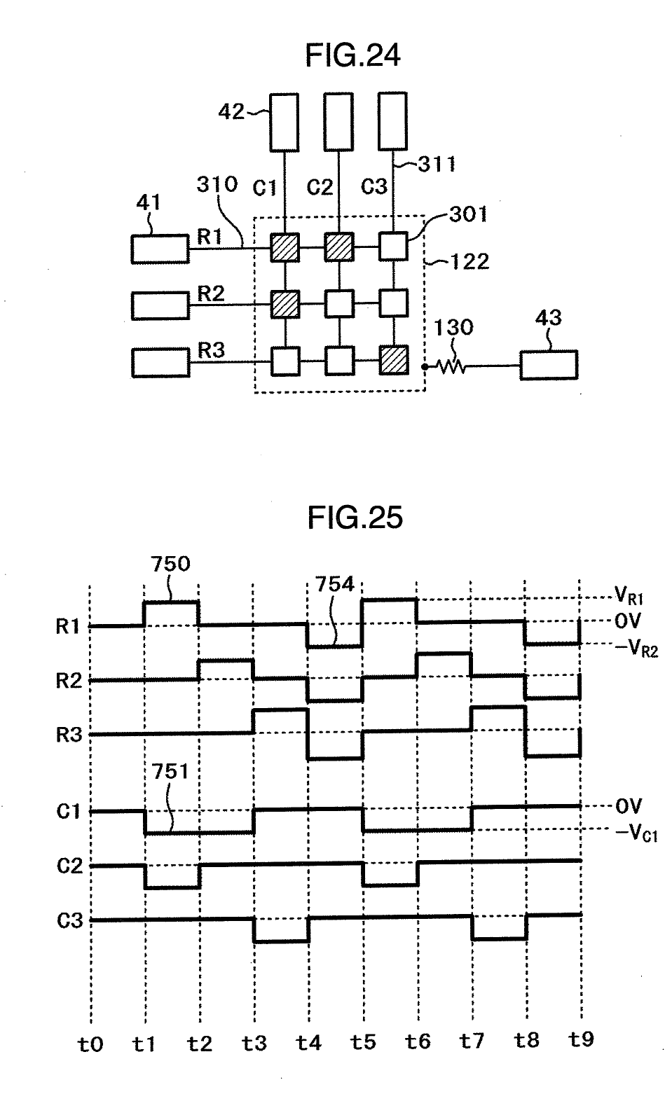

FIG. 24 shows a configuration of drive circuitry of the display panel 100 thus manufactured in this way. Scan electrodes 310 are connected to scan electrode drive circuits 41, respectively. Data electrodes 311 are connected to data electrode drive circuits 42, respectively. Acceleration electrode 122 is connected via a resistor 130 to an acceleration electrode drive circuit 43. A dot at the intersection between the n-th scan electrode 310Rn and m-th data electrode 311Cm is indicated by (n,m).

The resistor 130 has a resistance value, which was set in the following way. For example, in a display apparatus with a diagonal screen size of 51 cm (20 inches), its surface area is 1240 cm². When a distance between acceleration electrode 122 and cathode is set at 2 mm, the electrostatic capacitance Cg between acceleration electrode 122 and cathode becomes about 550 pF. To obtain the time constant that is sufficiently longer than the occurrence time duration of a vacuum discharge (about 20 nanoseconds), e.g., 500 nsec, the resistance value Rs of resistor 130 may be set to 900Ω or more. In this embodiment, it was set at 18 kΩ (time constant Tc=10 μs). By inserting the resistor with its resistance value satisfying a relation of Tc=Rs×Cg>20 ns between the acceleration electrode 122 and acceleration electrode drive circuit 43 in this way, it is possible to advantageously suppress unwanted occurrence of a vacuum discharge within the display panel.

FIG. 25 shows waveforms of some voltages generated at respective drive circuits. Although not specifically shown in FIG. 25, a voltage of about 3 to 10 kV (phosphor screen voltage Va) is applied to the acceleration electrode 122. At time point t0, any one of the electrodes is set at 0V so that no electrons are emitted, causing phosphor 114 to emit no light rays.

At time point t1, a scan pulse 750 with a voltage V_{R1} is applied to scan electrode 310R1, and a data pulse 751 of voltage −V_{C1} is applied to data electrodes 311C1 and 311C2. As a voltage V_{C1}+V_{R1} is applied between base electrode 13 and top electrode 11 of dots (1,1) and (1,2), electrons are emitted from thin-film electron emitters of these two dots into vacuum 10 as far as the voltage V_{C1}+C_{R1} is set to higher than a threshold voltage for startup of electron emission. In this embodiment, V_{R1}=+5V and −V_{C1}=−4V. The electrons emitted are accelerated by a voltage being applied to acceleration electrode 122 and, thereafter, collide with phosphor 114, causing it to emit light.

At time point t2, the voltage V_{R1} is applied to a scan electrode 310R2 while at the same time applying voltage −V_{C1} to data electrode 311C1, a dot (2,1) turns on in a similar way. Upon application of the voltage waveforms of FIG. 25 in this way, only selected dots with hatching applied thereto in FIG. 24 are driven to turn on.

In this way, changing the signals applied to data electrodes 311 makes it possible to display a desired image or information. In addition, by appropriately varying the amplitude of the application voltage −V_{C1} in accordance with an image signal, it is possible to display images with gray scale.

As shown in FIG. 25, at time point t4, a voltage −V_{R2} is applied to all of the scan electrodes 310. In this embodiment, −V_{R2}=−5V. The voltage being applied to all data electrodes 311 at this time is 0V so that the voltage VR2=−5V is applied to thin-film electron emitter 301. By application of the voltage that is opposite in polarity to the voltage during the electron emission event, i.e., reverse pulse 754, it is possible to liberate electrical charges that are accumulated in the traps within the insulator 12, thereby enabling the thin-film electron emitter to improve in lifetime characteristics. In addition, application of reverse pulse 754 within the vertical blanking period of a video signal leads to a good match with the video signal.

In an explanation of FIGS. 24 and 25, though the explanation was made by using an example of 3×3 dot for simplicity, in an actual image display apparatus, the number of scan electrodes is several hundreds to several thousands lines, and the number of the data electrodes is also several hundreds to several thousands lines.

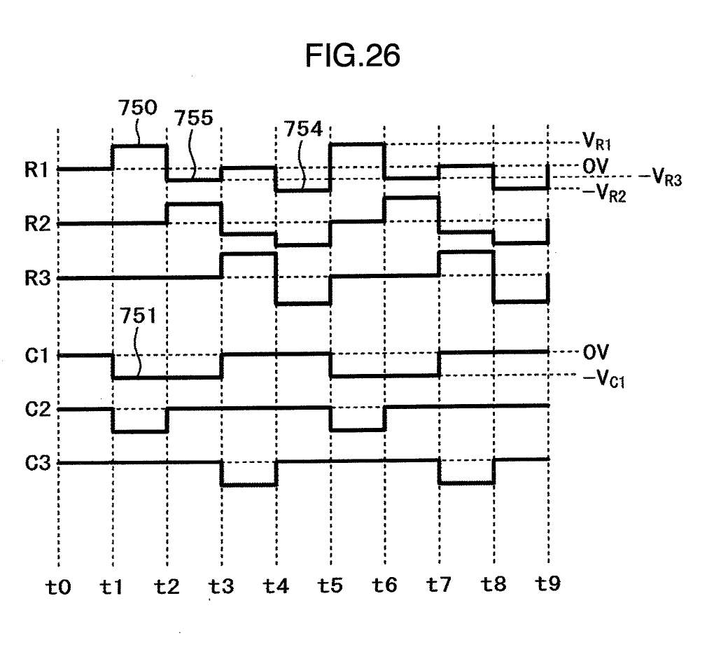

FIG. 26 shows another drive method. In this embodiment, the scan pulse 750 is applied to scan electrode R2 within a time period between time points t2 and t3 while simultaneously applying focus pulse 755 (voltage is −V_{R3}) to its neighboring scan electrode R1. By appropriately setting the voltage of the scan-line protrusion (focus electrode) in this way, it is possible to optimize the voltage relation of scanline protrusion 315, contact electrode 55 and top electrode 11. This makes it possible to obtain a further improvement in the beam focusing effect.

As apparent from FIGS. 1A, 1B and 13, this embodiment is such that the feeding electrode 305 (corresponding to contact electrode 55 of FIG. 13) for electrically feeding electron emission area 35 is provided along the longer side of electron emission area 35, whereby the current feeding ability is kept higher. Thus it is possible to obtain and retain increased feeding ability even when top electrode 11 is made thinner. This makes it possible to enhance the electron emission efficiency owing to the thickness reduction of top electrode 11. In addition, an increase in length of the feeding side results in alleviation of the current concentration to a specific region of the top electrode. Thus, the top electrode is improved in reliability.

The scan-line protrusion 315 is provided at the neighboring scan line 301 (corresponding to bus electrode 32 in FIG. 13), which is provided along the longer side of electron emission area 35. With this arrangement, the electron beam that was emitted is focused by the electron lens effect owing to the scanline protrusion 315, thus making it possible to provide an advanced high-definition image display apparatus with increased image resolution.

By applying an adequate voltage to the neighboring scan line 310 within a time period for emitting electrons by applying the scan pulse to scan line 301 (corresponding to busline electrode 32 in FIG. 13), it is possible to optimize the electron lens that is formed by scan-line protrusion 315 (focus electrode), thereby enabling further improvement of the beam focusing property.

As apparent from the foregoing, one important feature of the drive method of this embodiment lies in that the drive circuit connected to a scan line outputs at least three values of voltage in a display period within one field period of video signal: the scan pulse voltage V_{R1}, the scan-line non-selection voltage (although this voltage is 0V in this embodiment, this may be set at potential levels other than 0V), and the focus pulse voltage −V_{R3}. The “display period” refers to a time period which is equal to one field period of video signal with the vertical blanking period being excluded therefrom. In other words, it is the period for sequential output of scan pulses. As stated previously, use of this scheme makes it possible to further improve the beam focusing ability. Additionally, in this embodiment, the reverse pulse (voltage −V_{R2}) is applied within the blanking period.

Also note that in the case of the thin-film electron emitter being used as electron emission element 301 as in this embodiment, display images are free from influences even when applying the reverse polarity of voltage (i.e., the voltage that causes the top electrode to become negative in polarity relative to the base electrode) to the electron emission element. The reason of this is as follows. As apparent from the electron energy band diagram shown in FIG. 3, in case the voltage is given which causes the top electrode to be negative in polarity relative to the base electrode, electrons attempt to flow from the top electrode toward base electrode whereby no electrons are escaped into the vacuum so that any unnecessary phosphor luminescence does not take place. Accordingly, when selecting the reverse polarity voltage as the focus pulse voltage −V_{R3}, the focus pulse voltage becomes wider in margin. Thus, the optimization of the beam focusing property becomes easier. This advantage is unique to the image display apparatus embodying the invention, which uses thin-film electron emitters as its electron emission elements.

### Embodiment 3

This embodiment is an example which is characterized in that the focus electrode is used to create a lateral electric field to thereby have the function of bending or curving the trajectory of an electron beam in addition to the beam focusing ability.

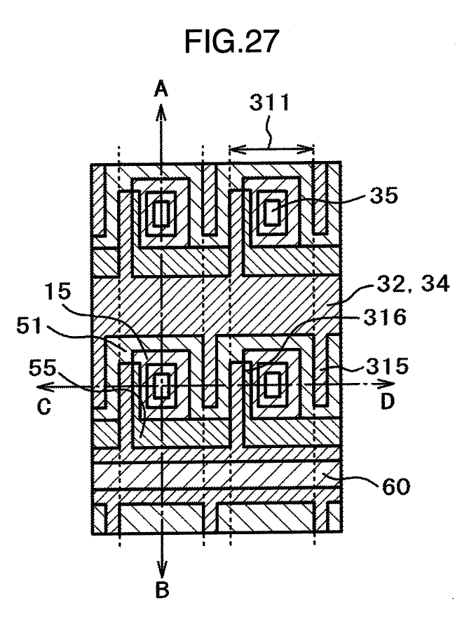

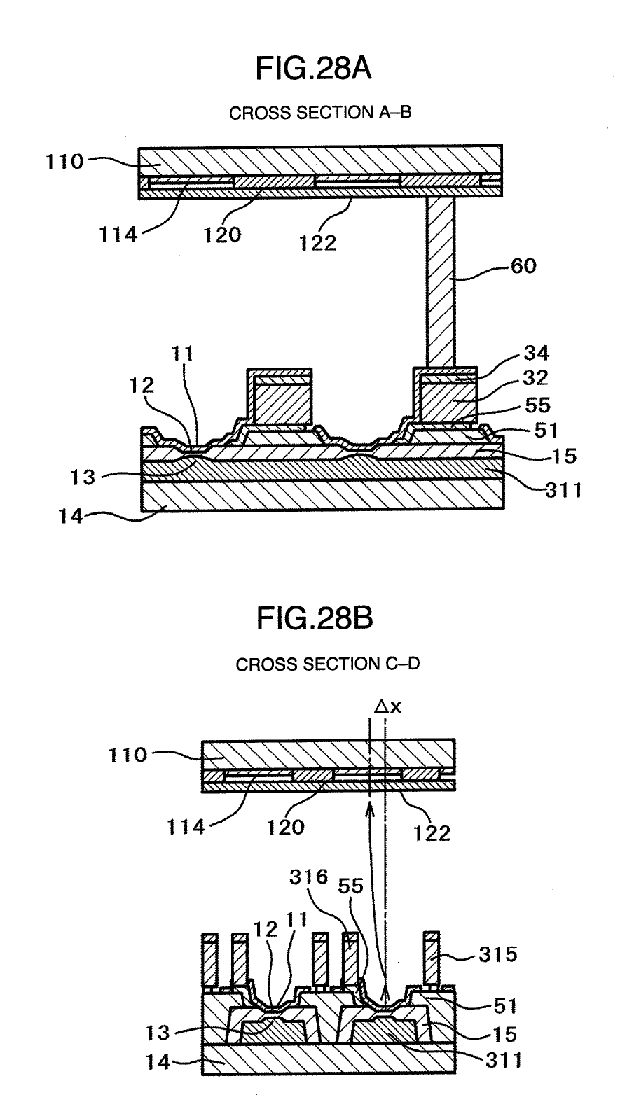

A top plan view of a display panel for use in this embodiment is shown in FIG. 27, and its sectional views are shown in FIGS. 28A and 28B. FIG. 27 is a plan view of part of a cathode plate 601. FIGS. 28A and 28B show sectional views of the part of cathode plate 601 corresponding to FIG. 27. FIG. 28A is a sectional view taken along line A-B of FIG. 27, and FIG. 28B is a sectional view along line C-D of FIG. 27. Note here that, in the plan view of FIG. 27, the top electrode 11 is removed for an illustrative purpose. As apparent from viewing the sectional views of FIGS. 28A and 28B, a film of top electrode 11 is formed on an overall surface.

A difference of this embodiment from the embodiment 2 shown in FIGS. 14A and 14B is that the former has an additionally provided scan-line protrusion (scan-line feed-side protrusion 316) on the contact electrode 55 that functions as current feeding electrode. A fabrication method of the cathode plate having the structure shown in FIGS. 27 and 28A-28B is similar to that of the embodiment 2, except that a pattern used at the patterning step of busline electrode 32, 34 is changed from that of the embodiment 2.

In this embodiment, the center line (indicated by dash-and-dot line in FIG. 28B) of a phosphor area 114 which was formed by patterning the phosphor in a way corresponding to a subpixel is disposed to have a positional offset Δx relative to the center line (indicated by dash-and-dot line in FIG. 28B) of electron emission unit 35. This layout design is in conformity to the fact that the trajectory of an electron beam emitted exhibits deflection as will be described later. Preferably, the offset Δx is set to 20 μm or greater. The position alignment accuracy of a substrate 14 and faceplate 110 is typically about ±5 μm. Setting the offset Δx to 20 μm or more makes it possible to accurately align together the electron beam center and the phosphor center through adjustment of a voltage being applied to the focus electrode, thereby, to cancel out possible deviations of the alignment between substrate 14 and faceplate 110.

Electrical connection with drive circuitry of the display panel of this embodiment is similar to that shown in FIG. 24. Output signal waveforms of the drive circuitry are similar to those shown in FIG. 26. In this embodiment, the scan pulse 750 is applied to scan electrode R2 within a time period between time points t2 and t3, and the focus pulse 755 (voltage −V_{R3}) is applied to its neighboring scan electrode R1.

Now consider an electron emission element which is electrically connected to the scan line R2. Within the period t2-t3, voltage V_{R1} is applied to scan-line feed-side protrusion 316 while letting voltage −V_{R3} (voltage of focus pulse 755) be applied to scan-line protrusion 315. As V_{R1}>-V_{R3}, a lateral electric field is created in the space between scan-line feed-side protrusion 316 and scan-line protrusion 315. Due to this field creation, the electron beam trajectory is deflected, resulting in likewise deviation of the “landing” position of an electron, at which the electron falls onto a phosphor screen. In tune with this landing position deviation, the center position of phosphor area 114 is offset by Δx from the center of electron emission unit.

This embodiment has advantages which follow. Firstly, the landing position of an electron beam is adjustable by adjustment of the voltage −V_{R3} of focus pulse 755. This makes it possible to electrically compensate for any possible alignment deviation between the phosphor screen and the substrate otherwise occurring during fabrication of the display panel, by adjustment of the application voltage of drive circuitry. This results in an increase in fabrication process margin of the display panel, thereby reducing process complexities. This is important, in particular, for the manufacture of a high-definition image display apparatus incorporating the principles of this invention.

In prior art device designs, it has been merely needed to align together the electron emission area's center and the phosphor center since electron beams emitted from thin-film electron emitters are good in go-straight property, i.e., spatial directionality. On the contrary, according to this invention, the prior art design is intentionally modified to use an arrangement for causing the beam to exhibit deflection to thereby provide a panel structure with the electron emission area's center and the phosphor center being offset to each other, thus rendering the beam's landing position electrically adjustable. This is one unique feature of this invention.

According to this invention, the focus pulse voltage −V_{R3} for adjustment of the deflection amount of an electron beam is settable independently of operation voltages of electron emission elements because of the fact that such voltage is the voltage to be applied to the neighboring scan line of a target scan line which is selected for operation. In other words, the beam landing position adjustment and the operation voltage adjustment are executable in a way independently of each other, resulting in an increase in device design flexibility.

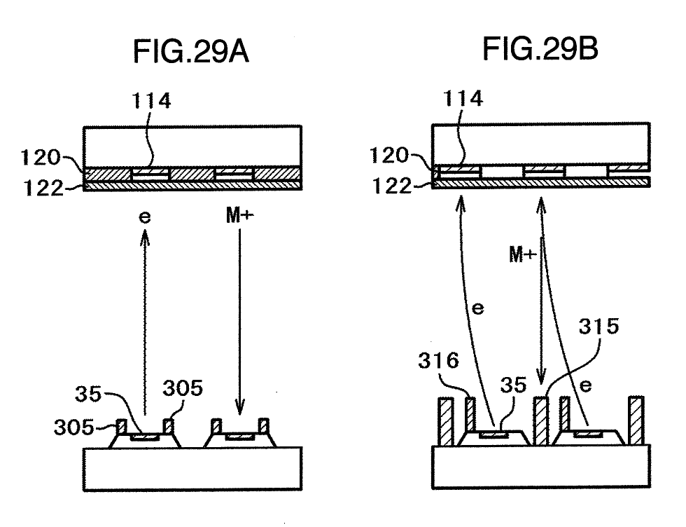

A second advantage of this embodiment is that an arrangement of this embodiment shifts the ion generation position from the electron emission area, and thereby reduces the amount of ions irradiated onto an electron emission area. This will be explained with reference to FIGS. 29A and 29B below.

FIGS. 29A-29B are diagram each showing a schematic representation of an electron beam trajectory and an ion trajectory within display panels. FIG. 29A shows the case of a prior known cathode structure; FIG. 29B is in the case of a cathode structure of this embodiment. First, the prior art cathode structure of FIG. 29A will be described. Consider a case where a voltage of Va=7 kV is applied to acceleration electrode 122. Since an electron beam emitted from electron emission area 35 of thin-film electron emitter is excellent in spatial directionality, it “lands” onto the phosphor screen at a point on a straight line segment above the electron emission area after having accelerated by an electric field created between acceleration electrode 122 and substrate 14. As the electron beam has its kinetic energy of several kV to Va (=7 kV) at a position near the phosphor plate, residual gases within the panel are ionized to produce positive ions (M+ in the figure). These positive ions are guided to go straight due to the electric field created between acceleration electrode 122 and substrate 14 and then bombard onto the electron emission area 35.

The energy of the ion at a time of incidence onto the electron emission area reaches Va (=7 kV) in maximum, so it can adversely affect the characteristics of thin-film electron emitter. Next, FIG. 28B schematically shows a display panel structure of this embodiment. The trajectory of electron beam is deflected due to the presence of a lateral-direction electric field, which is created in the space between the scan-line feed-side protrusion 316 and scan-line protrusion 315. This results in the ion production location also being shifted. Since the ion is larger in mass than the electron, it goes straight through the panel interior to fall onto the substrate. Thus, no ions bombard onto electron emission area 35. This makes it possible to prevent deterioration of the thin-film electron emitter's characteristics.

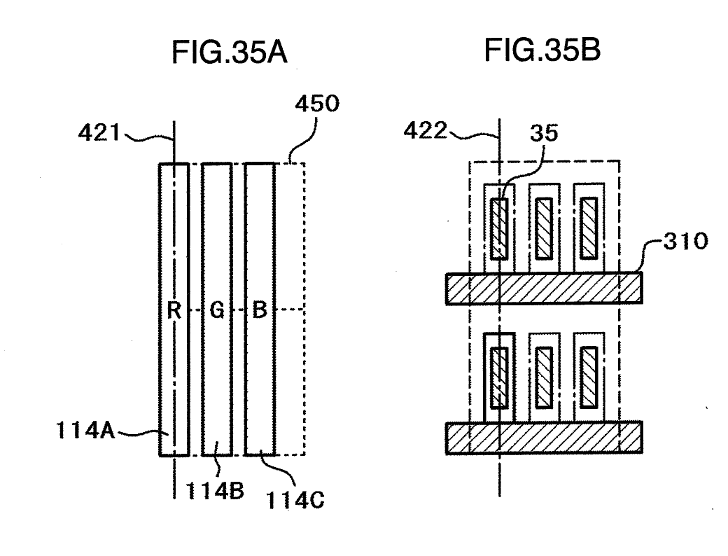

Another embodiment of this invention will be described using FIGS. 35A and 35B. FIG. 35A is a plan view of a layout pattern of phosphors 114 on phosphor plate 602. A frame of dotted lines in FIG. 35A or 35B indicates a region corresponding to one pixel. FIG. 35B shows a layout of electron emission areas 35 and scan lines 310 on cathode plate 601 in a region corresponding to FIG. 35A. In this embodiment, phosphor areas 114 are formed into strip-like shapes, each of which couples together those phosphor areas of the same color. Using this layout makes it possible to reduce process complexities in the fabrication of such phosphor areas.

A center axis 421 of strip-shaped phosphor area 114 and a center axis 422 of electron emission area 35 are shifted in position from each other. With this arrangement also, the above-stated effects are obtainable.

### Embodiment 4

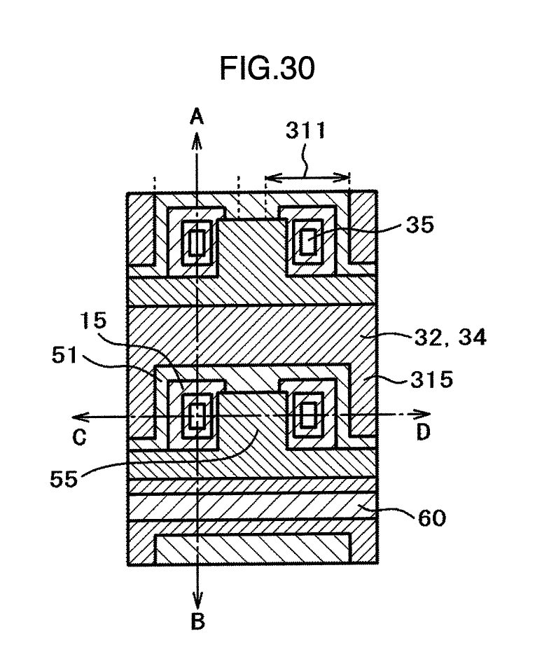

A fourth embodiment of this invention will be described with reference to FIG. 30.

FIG. 30 is a plan view of part of a cathode plate 601 used in this embodiment. This corresponds to that shown in FIG. 13 in the second embodiment. As apparent from comparison between FIG. 13 and FIG. 30, this embodiment is arranged so that a contact electrode 55 (feeding electrode) is commonly used or “shared” by two separate pixels, and scan-line protrusion 315 used for the beam focusing is also shared by two pixels. With such arrangement, the pattern alignment margin becomes greater, resulting in a decrease in fabrication process complexity.

### Embodiment 5

An image display apparatus using surface-conduction electron emitter (SCE) elements as thin-film electron emitters 301 in accordance with a fifth embodiment of this invention will be described.

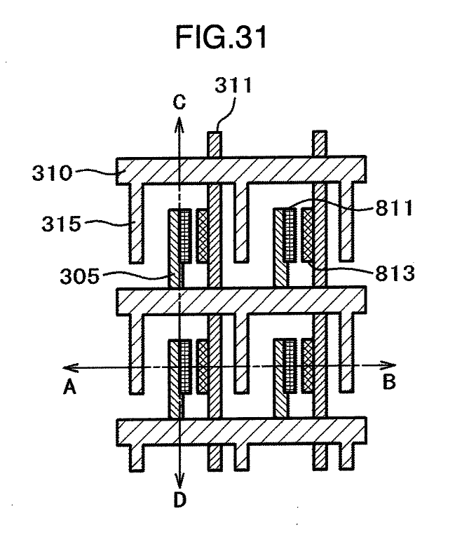

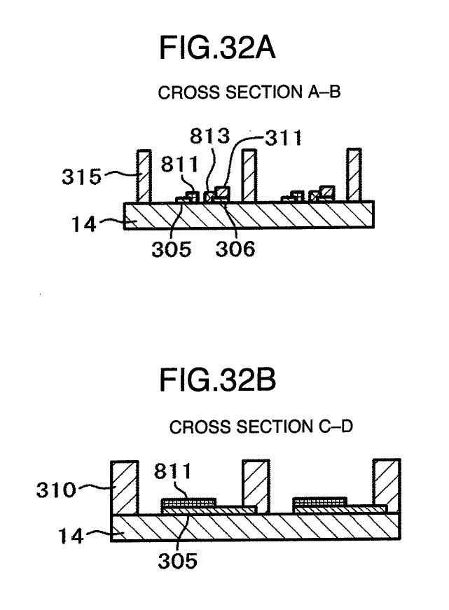

FIG. 31 is a diagram showing a plan view of part of a cathode plate 601 used in this embodiment. FIGS. 32A and 32B show sectional views of a part of cathode plate 601, corresponding to FIG. 31. FIG. 32A is a sectional view as taken long line A-B of FIG. 31, and FIG. 32B is a sectional view long line C-D of FIG. 31.

Scan lines 310 and data lines 311 are disposed on a glass substrate 14 in such a manner as to planarly cross together at right angles. An inter-layer insulating film (not shown) is inserted between scan lines 310 and data lines 311 for electrical isolation therebetween. A electron emission element 301 corresponding to a subpixel is formed in vicinity to a surface area in which a scan line and a data line cross together. The electron emission element is made up of an anode electrode film 811 and a cathode electrode film 813. The anode electrode film 811 is connected to scan line 310 via feeding electrode 305 whereas the cathode electrode film 813 is connected to data line 311 via an interconnect electrode 306.

The anode electrode film 811 and cathode electrode film 813 are each constituted from a lamination of an ultrafine-particle palladium oxide (PdO) film and a carbon film coated thereon. A gap 812 of about several nanometers is formed between anode electrode film 811 and cathode electrode film 813. Upon application of a voltage between anode electrode film 811 and cathode electrode film 813, electron emission occurs at this gap 812. In this embodiment, gap 812 is regarded to be an electron emission area as stated previously in conjunction with FIGS. 10A-10B.

Details of a fabrication method of the cathode plate 601 are disclosed, for example, in Journal of the SID, Vol. 5, pp. 345-348 (1997). This invention is characterized in that the scan line 310 has scan-line protrusion 315. This is manufacturable by modifying the pattern of scan lines.

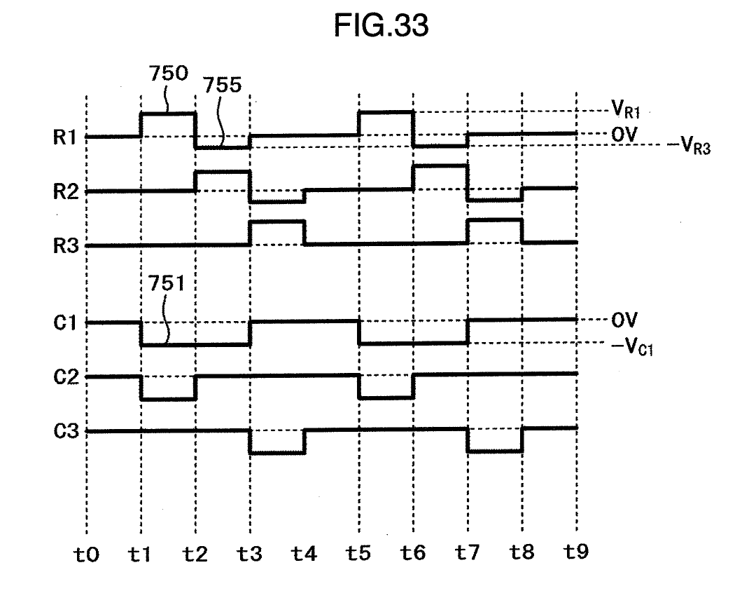

Electrical connection between the display panel of this embodiment and its associated drive circuitry is the same as that shown in FIG. 24. Output voltage waveforms of the drive circuit of this embodiment are shown in FIG. 33. A scan pulse 750 of a voltage V_{R1} is sequentially applied to a scan line; simultaneously, a focus pulse 755 of a voltage −V_{R3} is applied to its adjacent scan line. A signal pulse 751 is applied to a data line(s) in a way corresponding to an image signal. From a subpixel with both the scan pulse 750 and the signal pulse 755 being applied thereto at a time, electrons are emitted, causing its corresponding phosphor to yield light.

In this way, in the electron emission event, the voltage of scan electrode protrusions 315 which are provided on both sides of an electron emission element is set at −V_{R3}. Accordingly, by appropriately setting the voltage −V_{R3} of focus pulse 755, it is possible to optimize the electron lens that is formed by the scan electrode protrusion 315, thereby enabling achievement of higher beam-focusing ability.

It should be noted that the cathode electrode film 813 may be connected to the scan line 310 whereas the anode electrode film 811 may be connected to data line 311. In this case, the scan pulse 750 is modified to have a negative voltage, and the signal pulse 751 is set at a positive voltage. With this arrangement also, similar effects are obtainable.

It should be further understood by those skilled in the art that although the foregoing description has been made on embodiments of the invention, the invention is not limited thereto and various changes and modifications may be made without departing from the spirit of the invention and the scope of the appended claims.

1. An image display apparatus comprising a display panel having a cathode plate and a phosphor plate, and a drive circuit, wherein
said cathode plate has a plurality of electron emission elements, a plurality of parallel scan lines and a plurality of parallel data lines crossing at right angles to the scan lines,
each of said electron emission elements has a first electrode electrically connected via a feeding electrode to a corresponding one of said scan lines and a second electrode electrically connected to a corresponding one of said data lines,
each said electron emission element has an electron emission area for emitting an electron upon application of a voltage between said first electrode and said second electrode,
said phosphor plate has a phosphor and an acceleration electrode for causing the emitted electron to excite the phosphor for light emission to thereby permit said image display apparatus to display an image, and
said feeding electrode is connected to one side of the scan line, a longer side of those sides forming said electron emission area is used as a feeding side connected to said feeding electrode, a focus electrode is provided at a position opposing said feeding electrode with said electron emission area being interposed therebetween, and said focus electrode is connected to an adjacent scan line of said scan line.

2. The image display apparatus according to claim 1, wherein said focus electrode is provided along a side opposing said feeding side.

3. The image display apparatus according to claim 1, wherein said focus electrode extends from said scan line and protrudes in a direction at right angles to said scan line.

4. The image display apparatus according to claim 1, wherein said focus electrode is formed of the same layer as said scan electrode.

5. The image display apparatus according to claim 1, wherein an applied voltage of said feeding electrode and an applied voltage of said focus electrode are different from each other.

6. The image display apparatus according to claim 1, wherein said device uses a line-sequential drive method including the steps of sequentially applying a scan pulse to said plurality of scan lines and causing said electron emission element to emit an electron within a time period for application of the scan pulse to thereby cause said phosphor to emit light, and wherein
the drive circuit outputs to said scan line at least three kinds of voltages including a scan pulse voltage, a non-selection voltage and a focus voltage in such a way that the focus voltage is applied to said focus electrode adjacent to said electron emission area during application of said scan pulse.

7. The image display apparatus according to claim 1, wherein said electron emission area has a rectangular shape two neighboring sides including a longer side, which are for use as the feeding sides, and wherein said focus electrode is provided along a side that opposes one of said two feeding sides, which is not shorter than a remaining one thereof.

8. An image display apparatus comprising a display panel having a cathode plate and a phosphor plate, and a drive circuit, wherein
said cathode plate has a plurality of electron emission elements, a plurality of parallel scan lines and a plurality of parallel data lines crossing at right angles to the scan lines,
each of said electron emission elements has a first electrode electrically connected via a feeding electrode to a corresponding one of said scan lines and a second electrode electrically connected to a corresponding one of said data lines,
each said electron emission element has an electron emission area for emitting an electron upon application of a voltage between said first electrode and said second electrode,
said phosphor plate has a phosphor and an acceleration electrode for causing the emitted electron to excite the phosphor for light emission to thereby permit said image display apparatus to display an image,
said feeding electrode is connected to one side of the scan line, a longer side of those sides forming said electron emission area is used as a feeding side connected to said feeding electrode, a focus electrode is provided at a position opposing said feeding electrode with said electron emission area being interposed therebetween, and said focus electrode is connected to an adjacent scan line of said scan line,
said phosphor has a phosphor area corresponding to each pixel or each sub-pixel, and
a center line extending in a direction at right angles to said scan line and indicating a position of said electron emission area and a center line extending in a direction at right angles to said scan line and indicating a position of said phosphor area are formed so that these center lines are offset in a direction in which an electron beam is deflected by a difference between a voltage of said first electrode and a voltage to be applied to said focus electrode.

9. The image display apparatus according to claim 8, wherein an amount of the offset as formed in the electron beam deflection direction is more than or equal to 20 μm.

10. The image display apparatus according to claim 8, wherein said phosphor has a phosphor area with a stripe-form corresponding to each linear array of pixels or sub-pixels.

11. An image display apparatus comprising a display panel having a cathode plate and a phosphor plate, and a drive circuit, wherein
said cathode plate has a plurality of electron emission elements, a plurality of parallel scan lines and a plurality of parallel data lines crossing at right angles to the scan lines,
each said electron emission element is a thin-film electron emitter comprising a first electrode which forms a top electrode, a second electrode which forms a base electrode, and an electron acceleration layer interposed between said first electrode and said second electrode, for emitting an electron from said first electrode upon application of a voltage between said first electrode and said second electrode,
said first electrode is electrically connected via a feeding electrode to said scan line whereas said second electrode is electrically connected to said data line,
said phosphor plate has a phosphor and an acceleration electrode for causing the emitted electron to excite the phosphor for light emission to thereby permit said image display apparatus to display an image, and
said feeding electrode is connected to one scan line of said scan lines, a longer side of those sides forming said electron emission area is a feeding side connected to said feeding electrode, a focus electrode is provided at a position opposing said feeding electrode with said electron emission area being interposed therebetween, and said focus electrode is connected to an adjacent scan line of said scan line.

12. The image display apparatus according to claim 11, wherein said focus electrode is provided along a side opposing said feeding side.

13. The image display apparatus according to claim 11, wherein said focus electrode extends from said scan line and protrudes in a direction at right angles to said scan line.

14. The image display apparatus according to claim 11, wherein said focus electrode is formed of the same layer as said scan electrode.

15. The image display apparatus according to claim 11, wherein an applied voltage of said feeding electrode and an applied voltage of said focus electrode are different from each other.

16. An image display apparatus comprising a display panel having a cathode plate and a phosphor plate, and a drive circuit, wherein
said cathode plate has a plurality of electron emission elements, a plurality of parallel scan lines and a plurality of parallel data lines crossing at right angles to the scan lines,
each said electron emission element is a thin-film electron emitter comprising a first electrode which forms a top electrode, a second electrode which forms a base electrode, and an electron acceleration layer interposed between said first electrode and said second electrode, for emitting an electron from said first electrode side upon application of a voltage between said first electrode and said second electrode,
said first electrode is electrically connected via a feeding electrode to said scan line whereas said second electrode is electrically connected to said data line,
said phosphor plate has a phosphor and an acceleration electrode for causing the emitted electron to excite the phosphor for light emission to thereby permit said image display apparatus to display an image,
said feeding electrode is connected to one scan line of said scan lines, a longer side of those sides forming said electron emission area is a feeding side connected to said feeding electrode, a focus electrode is provided at a position opposing said feeding electrode with said electron emission area being interposed therebetween, and said focus electrode is connected to a neighboring scan line of said scan line, and
said phosphor has a phosphor area corresponding to each pixel or each sub-pixel, and a center line extending in a direction at right angles to said scan line and indicating a position of said electron emission area and a center line extending in a direction at right angles to said scan line and indicating a position of said phosphorus area are formed so that these center lines are offset in a direction in which an electron beam is deflected by a difference between a voltage of said first electrode and a voltage to be applied to said focus electrode.

17. The image display apparatus according to claim 16, wherein an amount of the offset as formed in the electron beam deflection direction is more than or equal to 20 μm.

18. An image display apparatus comprising a display panel having a cathode plate and a phosphor plate, and a drive circuit, wherein
said cathode plate has a plurality of electron emission elements, a plurality of parallel scan lines and a plurality of parallel data lines crossing at right angles to the scan lines,
each said electron emission element has a first electrode and a second electrode which are disposed to oppose each other with a distance being defined therebetween on a flat plane, said first electrode is electrically connected via a feeding electrode to a corresponding one of said scan lines, said second electrode is electrically connected to a corresponding one of said data lines,
said electron emission element emits an electron between said first electrode and said second electrode in response to application of a voltage between the first and second electrodes, said phosphor plate has a phosphor and an acceleration electrode for causing the emitted electron to excite the phosphor for light emission to thereby permit said image display apparatus to display an image, and
said feeding electrode is connected to one scan line of said scan lines, a long side of those sides forming said electron emission area is a feeding side connected to said feeding electrode, a focus electrode is provided at a position opposing said feeding electrode with said electron emission area being interposed therebetween, and said focus electrode is connected to a neighboring scan line of said scan line.

19. The image display apparatus according to claim 18, wherein an applied voltage of said feeding electrode and an applied voltage of said focus electrode are different from each other.
